(19) United States
(12) Patent Application Publication
(10) Pub. No.: US 2021/0002531 A1
(43) Pub. Date: Jan. 7, 2021

(54) FLOCKED PRODUCTS HAVING A SILICONE ADHESIVE COMPOSITION AND METHODS OF MAKING AND USING THE SAME

(71) Applicant: Sandcore Technologies, LLC, Ft. Collins, CO (US)

(72) Inventor: Louis Brown Abrams, Fort Collins, CO (US)

(21) Appl. No.: 17/026,612

(22) Filed: Sep. 21, 2020

Related U.S. Application Data
(62) Division of application No. 15/847,589, filed on Dec. 19, 2017, now abandoned.
(60) Provisional application No. 62/552,178, filed on Aug. 30, 2017.
(60) Provisional application No. 62/533,480, filed on Jul. 17, 2017.
(60) Provisional application No. 62/527,322, filed on Jun. 30, 2017.
(60) Provisional application No. 62/467,664, filed on Mar. 6, 2017.
(60) Provisional application No. 62/463,082, filed on Feb. 24, 2017.
(60) Provisional application No. 62/459,823, filed on Feb. 16, 2017.
(60) Provisional application No. 62/455,875, filed on Feb. 7, 2017.
(60) Provisional application No. 62/454,586, filed on Feb. 3, 2017.
(60) Provisional application No. 62/447,511, filed on Jan. 18, 2017.
(60) Provisional application No. 62/436,284, filed on Dec. 19, 2016.

(51) Int. Cl. C09J 183/04; C09J 7/30; C09J 7/35; C09J 5/00; B05D 1/06; B05D 1/32; B05D 1/14; B05D 1/28

(52) U.S. Cl. CPC C09J 183/04; C09J 7/30; C09J 7/35; C09J 5/00; C08G 77/12; B05D 1/32; B05D 1/14; B05D 1/286; C09J 2483/00; B05D 1/06

(57) ABSTRACT

This invention relates generally to flocked articles and methods for making the same, more particularly to flocked products having a silicone adhesive and methods for making and using the same.

### CROSS REFERENCE

The present application is a divisional of U.S. patent application Ser. No. 15/847,589, filed on Dec. 19, 2017, which claims the benefits of U.S. Provisional Application Ser. No. 62/436,284, filed Dec. 19, 2016, Provisional Application Ser. No. 62/447,511, filed Jan. 18, 2017, Provisional Application Ser. No. 62/454,586, filed Feb. 3, 2017, Provisional Application Ser. No. 62/455,875, filed Feb. 7, 2017, Provisional Application Ser. No. 62/459,823, filed Feb. 16, 2017, Provisional Application No. 62/463,082, filed Feb. 24, 2017, Provisional Application No. 62/467,664, filed Mar. 6, 2017, Provisional Application Ser. No. 62/527,322, filed Jun. 30, 2017, Provisional Application Ser. No. 62/533,480, filed Jul. 17, 2017, and Provisional Application Ser. No. 62/552,178, filed Aug. 30, 2017, each entitled “Flocked Transfer having a Silicone Flock Adhesive Composition and Methods of Making and Using the Same”, and each of which is incorporated herein in its entirety by this reference.

### FIELD

The invention relates generally to flock transfers and appliqués, and particularly to flock transfers and appliqués and methods of make and using the same.

### BACKGROUND

Flock products of the prior art typically have three components: a thermoplastic or thermoset bottom component, a middle component comprising a thermoset water-based flock transfer adhesive, and a top component comprising flock. The function of the bottom component is to melt and flow into a substrate surface, cool, and solidify to form a mechanical or chemical adhesion to substrate. The function of the thermoset, water-based flock transfer adhesive is to form a durable adhesive bond with the bottom component and the flock. The thermoset, water-based flock transfer adhesive holds the product together and serves to create the shape of the product which is generally formed by printing or coating of the water-based adhesive in the desired shape and/or form. The thermoset, water-based adhesive is typically opaque. It also enhances the performance of the flock product with its integrity, adhesion, strength, and its other physical properties. The top flock component can have a single, multi-colored, or dyed flock fibers. The top flock layer can contain a visual image and/or a tactile and/or dimensionalized surface.

The middle component, the thermoset, water-based flock transfer adhesive, is generally a screen printable water-based latex adhesive. While the water-based thermoset adhesives are commercially successful, they do have some serious disadvantages and functional limitations. For example, about 60 wt. % of the printed material is water (and in some formulations can also include mineral spirits), and the remaining 40 wt. % being solids. The water is removed during processing and formation of the adhesive bond between the top flock layer and the bottom adhesive layer. The removal of the water from the printed water-based thermoset adhesive shrinks the printed adhesive layer. The removed water is not a component of the final flock product. Therefore, more than double the desired layer of adhesive thickness must be printed to achieve the desired final adhesive layer thickness. The 60 wt. % water (which cam also include mineral spirits in some formulations) increases the purchase and transportation costs of water-based, thermoset adhesives. Other disadvantages of the water-based adhesives of the prior art are that they can freeze in cold environments, they need to be heated during storage and transport during cold periods, the adhesive can dry on printing creating blockage (generally created by adhesive being retained in apertures of the printing screen) and cause product delays and rejection of product, they have a limited capacity of loading of titanium dioxide pigment to achieve opacity, they require a humid environment during printing to extend “open time” screen printing of the adhesive, they require a continuous need to wipe clean the printing screens to remove dried, blocking adhesive deposits on the screen, and they need more than an hour to allow for the water to be removed prior the final cure.

Yet another disadvantage of the printed and cured water-based, thermoset adhesives of the prior art is that they can become tacky when heat and pressure are applied to them. The tackiness can result in the flock being matted down into the adhesive layer during processing. The matting down can destroy the soft nature of flock upper layer. Moreover, in many applications, such as industrial work uniforms, require heat resistance that water-based thermoset latex adhesives fail to adequately provide. The water-based thermoset latex adhesives of the prior art also fail to qualify for in-mold applications such as during high temperature resin injection during molding.

The adhesion strength between the water-based, thermoset latex adhesives of the prior art and flock fibers is generally determined by the amount of contact between the latex adhesive and flock. For example, to obtain adequate adhesion between a flock fiber and a latex adhesive of the prior art, at least about 10% of the flock fiber length must be planted in the dried and cured latex adhesive. Another factor affecting the adhesive strength between the water-based, thermoset latex adhesive is the degree to which the hot-melt powder adhesive needs to sink into the latex adhesive. Yet another factor that affects the adhesion strength (tensile strength) of the water-based, thermoset latex adhesive is the thickness of printed latex adhesive. Each of these factors limit the ability to have thin, light-weight, streamlined flock product profiles. These factors also limit the opacity of the adhesive layer and the ability to flock over dark colored textiles, such as with white flock fibers over a dark colored textile or dark colored inserts and not have the dark color showing through the flock layer.

Yet another limitation of water-based, thermoset adhesives of the prior art is dye migration from textiles and/or flock that has been imprinted with a dye sublimation transfer ink. The dye migration typically occurs when heat and pressure are applied either during manufacture and/or application of the product to a substrate. For example, when heat and/or pressure are applied to white flock applied over red dye sublimation transfer print, the dye can migrate through the thermoset latex adhesive to flock and change the flock from white to pink. Still yet another limitation is the limited elastomeric properties of the thermoset latex adhesives, which effect the softness of the flock product and the substrates the flock can be applied to.

Furthermore, some water-based, thermoset adhesive latex chemistries are subject to environmental compliance restrictions. Such restrictions limit one or more of the methods by which the flock products can be made and markets that they can be used in.

Some prior art flock products are formed using a continuous film component for adhering flock to a substrate. A disadvantage of using continuous material is that it requires that unwanted inner “void” design areas (open spaces) be laboriously removed (“weeded”) to create the final product image. The continuous film products also have many of the above limitations.

A need exists for a better flock adhesive that is more convenient, efficient printability, and enhanced physical properties. Silicone adhesives overcome most, if not all, of the forementioned problems and limitations of above-mentioned flock adhesives of the prior art.

### SUMMARY

These and other needs are addressed by the various aspects, embodiments, and configurations of the present disclosure. This disclosure relates generally to flocked articles and methods for making them.

Silicone adhesives are used for flat ink heat transfers. Their use for flock products, both direct flock and flock transfer products, have not been found to work satisfactorily commercially. Some of the product problems encountered in flocking applications are suitable silicone adhesive print viscosity. Having a suitable print viscosity generally ensures that when the silicone is printed, the silicone deposited from the screen onto to the surface of flock is supported by the flock fibers and does not substantially sink down into spaces between the flock fibers. The viscosity of silicone adhesive should be sufficiently low enough to allow the flock fibers when contacted with the printed adhesive to be wetted by and adhered to the adhesive and have sufficiently high enough viscosity to allow the flock fibers stand proud in it. Similarly, the viscosity of silicone adhesive should be sufficiently low enough to allow any powder adhesive contacted with the printed adhesive be located in and/or on the silicone adhesive. It is desirable that the silicone adhesive have a viscosity to be able to be printed as a film and that the deposited adhesive film be thinner than the water-based latexes of the prior art. It is also desirable that the silicone adhesive printed film have a shrinkage less than the water-based latexes of the of the prior art. The shrinkage of the printed film refers to the change of the film thickness between two or more of the film thicknesses of as printed layer, the layer after drying, and the layer after curing. Yet another desired property of the silicone adhesive is that it has a greater adhesion to the flock fibers than the water-based latex adhesives of the prior art. Still yet another desired property of the silicone adhesive is that it has a greater adhesion to the flock fibers and that the adhesion be with a lower contact profile of the flock fiber with the adhesive. That is, the contact profile of the flock fiber with the silicone adhesive is less with the silicone adhesive than with the water-based latex adhesives of the prior art and that the adhesion strength of the flock fibers is greater with the silicone adhesive than with the water-based latex adhesives of the prior art. It can also be appreciated that less of the flock fiber contacts the silicone adhesive of the present disclosure than the water-based latex adhesives of the prior art. Still yet another desired property of the silicone adhesives of the present disclosure is that less, if any, of a hot melt-melt adhesive is needed to achieve adhesion of the silicone adhesive to the flock fiber.

Other properties, particularly unique to the silicone adhesives of the present disclosure are a suitable “open time” or “pot-life” of the catalyzed silicone to meet processing needs, such sufficient periods for printability and cure times. Another desired property is sufficient opacity of the cured silicone adhesive film.

Some of the differences between the flocking process of the prior art and that of present disclosure are: the silicone adhesives cure times are typical faster than the water-based latexes of the prior art; the silicone adhesives can be cured immediately after being contacted with the flock fibers; the silicone adhesives do not contain water and, therefore, do not require a drying period for the removal of the water; and the silicone catalyst can be poisoned by various materials, such as nitrogen, sulfur, alcohol and water, that is the poison can defeat the catalyzation process.

The present disclosure is generally related to direct-flocked products. The flock products are made with a polymerizable silicone rather than the flock products of water-based thermoset latexes. When the silicone adhesive is cured with a hot-melt adhesive a unique adhesive is formed. The silicone adhesive generally binds the flock to the item being decorated with one or more of greater adhesion and elastic properties than the water-based adhesives of the prior art. The silicone adhesives of the present disclosure provide one or more of unique chemical and physical benefits over the water-based adhesives of the prior art. The silicone adhesives of the present disclosure typically comprise one or more of a catalyst for polymerization of one more silicones, an adhesion promoter (or coupling agent), a rheology modifier, one or more pigments, and one or more dispersion aids. The hot-melt adhesive can be a thermoplastic adhesive, a thermoset adhesive, or a combination of thermoplastic and thermoset adhesives. As will be appreciated, the thermoset hot melt adhesives generally solidify or set irreversibly when heated above a certain temperature. This property is usually associated with a crosslinking reaction of the molecular constituents induced by heat and/or radiation. Thermoset adhesives can include curing agents. Examples of thermosetting adhesives include polyethylene, phenolics, alkyds, amino resins, polyesters, epoxides, polyurethanes, polyamides, and combinations thereof. Changes necessary to enable suitable use of the polymerizable silicone for manufacturing of flocked products and subsequent include without limitation: elimination, or minimization of water, select of catalyst and amount thereof, and elimination of any catalyst poisons. The advantages of a silicone adhesive over the water-based latex adhesives of the prior art are at least: reduced, or elimination, of screen blockage or delays due to screen blockage, greater opacity of the printed adhesive film (particularly with a thinner printed adhesive film), and elimination, or substantial reduction, of film drying (such as a water removal) stage prior to curing of the printed adhesive film. Some of the advantages of a cured silicone adhesive layer over a water-based adhesive layer are that the final flock product can be one or more of: ironed onto a substrate with little, if any, matting-down of the flock fibers, injected molded with little, if any, matting-down of flock fibers, printed over a dark colored substrate with little, if any, of dark substrate showing through the flock fibers, and adhered to textiles that have been previously imprinted with a dye sublimation transfer ink with little, if any transfer of the dye sublimation ink to the flock fibers.

The silicone adhesives are substantially more environmentally friendly adhesives than the water-based latex adhesives of the prior art. The silicone adhesives generally are substantially 100 wt. % solids, compared to water-based adhesives which have about 40 wt. % solids. The silicone adhesives generally have one or more of a lower cost of adhesive solids purchase price and a lower transportation cost per pound than the water-based adhesives of the prior art.

It has been found that one or more of the following effects the performance of flock product: the percent of the flock fiber surface area in contact with the silicone adhesive, the amount of air entrained in the silicone adhesive when screen printing, any additive to the silicone adhesive (such as any rheology modifier) should be fully wetted before screen printing of the silicone adhesive, and the adhesion process of the silicone to the flock fiber. It has been found that if too much of flock fiber surface is planted/located too deeply in an adhesive, the plushness of the flock product is negatively impacted, the flock layer is less plush and therefore less desired. It has also been found, that little, if any, air should be entrained in the silicone adhesive when the silicone adhesive is screen printed. Air entrained in the silicone adhesive generally increases the stringiness of the silicone adhesive during screen printing. Stringiness of the silicone effects the ability precisely and accurately screen print the adhesive. The stringier the silicone adhesive is the less precisely and/or less accurately the silicone can be screen printed. It has been found that fumed silica can be an appropriate rheology modifier of the silicone adhesive. It also been found the fumed silica should be fully wetted before the silicone adhesive is screen printed. If not, the screen printing process cannot be satisfactorily controlled. Addition of the fumed silica to the silicone to silicone adhesive can be by a dual asymmetrical centrifuge process. The dual asymmetrical centrifuge process can substantially fully wet the fumed silica when mixing the fumed silica with the silicone adhesive. Should any air be entrained in the silicone adhesive when mixing it silicone adhesive, it can be removed by a de-airing process. One suitable method of removing entrained air is to reduce the pressure above the silicone adhesive.

The adhesion strength can be affected by one or more of the silicone chemistry, the adhesion promoter (coupling agent), the amount of entrained air, any flock fiber surface treatment (such as any coating to assist in electro-deposition of the flock fiber), catalyst chemistry, and the rheology modifier to name a few. The adhesion strength is also affected when the chemistry of the flock fibers and the substrate substantially differ, such as when the flock fibers comprise nylon and the substrate comprise polyester.

One advantage of a direct flocking process is the elimination of a transfer sheeting having a release adhesive. Contacting of the flock fibers with the release adhesive can leave a residue on the flock fibers, which can reduce any subsequent adhesion of the flock fibers to a substrate. It is commonly believed as little as 0.01% of surface area of the flock fiber having release adhesive can diminish the adhesion of the flock fiber, more commonly as little as 0.05%, even more commonly as little as 0.1%, yet even more commonly as little as 0.2%, still yet even more commonly as little as 0.5%, still yet even more commonly as little as 1%, still yet even more commonly as little as 2%, still yet even more commonly as little as 5%, still yet even more commonly as little as 7.5%, or yet still even more commonly as little as 10%. Moreover, it is generally believed that that the adhesion of the flock layer can be affected when more than about 0.001% of the flock fibers comprising the flock layer contain a release adhesive residue, more generally more than about 0.005% of the flock fibers, even more generally more than about 0.01% of the flock fibers, yet even more generally more than about 0.02% of the flock fibers, still yet even more general more than about 0.05% of the flock fibers, still yet even more general more than about 0.075% of the flock fibers, still yet even more general more than about 0.1% of the flock fibers, still yet even more general more than about 0.15% of the flock fibers, still yet even more general more than about 0.2% of the flock fibers, still yet even more general more than about 0.25% of the flock fibers, still yet even more general more than about 0.5% of the flock fibers, still yet even more general more than about 0.75% of the flock fibers, still yet even more general more than about 1% of the flock fibers, still yet even more general more than about 2% of the flock fibers, still yet even more general more than about 2.5% of the flock fibers, still yet even more general more than about 5% of the flock fibers, still yet even more general more than about 7.5% of the flock fibers, or yet still even more general more than about 10% of the flock fibers.

In some embodiments, no more than about 0.01% of the surface area of one or more the flock fibers has release adhesive, more commonly no more than about 0.05% of the surface area of one or more the flock fibers has release adhesive, even more commonly no more than about 0.1% of the surface area of one or more the flock fibers has release adhesive, yet even more commonly no more than about 0.2% of the surface area of one or more the flock fibers has release adhesive, still yet even more commonly no more than about 0.5% of the surface area of one or more the flock fibers has release adhesive, still yet even more commonly no more than about 1% of the surface area of one or more the flock fibers has release adhesive, still yet even more commonly no more than about 2% of the surface area of one or more the flock fibers has release adhesive, still yet even more commonly no more than about 5% of the surface area of one or more the flock fibers has release adhesive, still yet even more commonly no more than about 7.5% of the surface area of one or more the flock fibers has release adhesive, or yet still even more commonly no more than about 10% of the surface area of one or more the flock fibers has release adhesive.

In some embodiments, no more than about 0.001% of the flock fibers of the flock layer contain a release adhesive residue, more generally more than about 0.005% of the flock fibers of the flock layer contain a release adhesive residue, even more generally more than about 0.01% of the flock fibers of the flock layer contain a release adhesive residue, yet even more generally more than about 0.02% of the flock fibers of the flock layer contain a release adhesive residue, still yet even more general more than about 0.05% of the flock fibers of the flock layer contain a release adhesive residue, still yet even more general more than about 0.075% of the flock fibers of the flock layer contain a release adhesive residue, still yet even more general more than about 0.1% of the flock fibers of the flock layer contain a release adhesive residue, still yet even more general more than about 0.15% of the flock fibers of the flock layer contain a release adhesive residue, still yet even more general more than about 0.2% of the flock fibers of the flock layer contain a release adhesive residue, still yet even more general more than about 0.25% of the flock fibers of the flock layer contain a release adhesive residue, still yet even more general more than about 0.5% of the flock fibers of the flock layer contain a release adhesive residue, still yet even more general more than about 0.75% of the flock fibers of the flock layer contain a release adhesive residue, still yet even more general more than about 1% of the flock fibers of the flock layer contain a release adhesive residue, still yet even more general more than about 2% of the flock fibers of the flock layer contain a release adhesive residue, still yet even more general more than about 2.5% of the flock fibers of the flock layer contain a release adhesive residue, still yet even more general more than about 5% of the flock fibers of the flock layer contain a release adhesive residue, still yet even more general more than about 7.5% of the flock fibers of the flock layer contain a release adhesive residue, or yet still even more general more than about 10% of the flock fibers of the flock layer contain a release adhesive residue.

Some embodiments can include a continuous production capability. The continuous production process comprises a process time of no more than about 5 minutes from printing of silicone adhesive to full cure of the silicone adhesive with the flock fibers adhered thereto. The process may or may not include a step of brushing the flock product. Processes of prior art, from printing of water-based adhesive to its full cure, generally have a process time of about 8 hours. These long processes are due at least to the water removal process. Another process time advantage is that the silicone adhesive commonly has little, if any, screening blocking compared to the water-based adhesive.

Some embodiments can include silicone adhesive screen prints having finer details than their water-based adhesive screen prints of the prior art. The finer details are believed to be due to non-aqueous chemistry of silicone adhesive.

Some embodiments can include silicone adhesive formulations having an adhesion strength greater than the water-based adhesive formulations of the prior art. The higher adhesion strength of silicone adhesive formulations is believed to be due to greater tensile strength of the silicone formulations compared to the water-based adhesives of the prior art. It is also believed that the greater tensile strength of the silicone adhesive formulations is due to the ability to combine them with micron sized thermo-adhesive powders.

Some embodiments can include silicone adhesive formulations with greater opacity than the water-based adhesives of prior art. This is believed to be due higher loading capacity for one or more of titanium dioxide, silica, fumed silica and such of the silicone adhesive formulations than the water-based adhesives of the prior art. It is believed that the greater load capacity of titanium dioxide, silica, and fumed silica could be due to one or more of the chemical compatibility, such as chemical similarity of the silicone adhesive with silica and fumed (the adhesive, the silica and the fumed have silicon-oxygen linkages) and similarly for the silicone adhesive and titanium, with silicon and titanium belonging to the same chemical family in periodic table. It also believed that the greater loading capacity could due to the ability to bind organofunctional groups such as alkyl, aryl, alkylsilicone and arylsilicone functional group on silica, titanium dioxide and fumed silica.

Some embodiments can include printed silicone adhesive formulations having a greater tensile strength per mil of thickness of the printed adhesive film than the water-based adhesives of the prior art. Some embodiments can include a cured silicone adhesive-based flock product having a greater tensile strength per mil of thickness of the printed adhesive than a cured water-based adhesive flock product of the prior art.

Some embodiments can include cured silicone adhesive formulations having a greater adhesion strength to flock fibers than the water-based adhesive formulations of the prior art.

Some embodiments can include a greater % of the flock fiber length being free of adhesive when the flock fiber is adhered to a silicone adhesive than when the adhesive is a water-based adhesive. This is believed to be due to greater adhesion strength of silicone adhesive formulations compared to the water-based adhesive formulations of the prior art. The greater the % of the flock fiber length being free of adhesive the greater plushness of flock layer. It is further believed that with a higher percent of the flock fiber extending out of the silicone adhesive compared to the water-based adhesives of the prior art, the flock fibers are more able to move and give a greater sense of softness.

Some embodiments can include a cured silicone adhesive layer having a lower durometer value, that is a softer adhesive layer, than the cured water-based adhesive layers of the prior art. Some embodiments can include a cured silicone-based flock product having a lower durometer value, that is a softer flock product than the cured water-based adhesive flock products of the prior art.

Some embodiments can include a silicone adhesive-based flock product having a more streamlined look and feel than the water-based-based adhesive products of the prior art. This is believed to be due to due cured silicone adhesive layer having a thickness substantially less than the thickness of water-based adhesives of the prior art.

Some embodiments can include cured silicone adhesive formulations having greater elastomeric properties than the water-based adhesives of the prior art. Some embodiments can include silicone-based flock products having greater elastomeric properties than the water-based adhesive flock products of the prior art.

Some embodiments can include a cured silicone-based flock product having greater wash fastness than water-based adhesive flock products. It is believed that the greater wash fastness of the silicone-based flock product is due to one or more of the greater adhesion of the silicone to the flock and higher heat resistance of the silicone adhesive compared to the water-based flock adhesives of the prior art.

Some embodiments can include a cured silicone-based flock product that is an iron over flock product. Some embodiments can include a cured silicone-based flock product that can be used in an in-mold process where a molten resin is injected into a mold containing the fold product.

Some embodiments can include a cured silicone-based flock product that can be an anti-migration barrier to prevent sub-dye transfer inks from coming in contact with the flock fibers.

Some embodiments can include printing the silicone adhesive directly onto a substrate, followed by direct flocking of the silicone adhesive printed on the substrate. The substrate can comprise one or more of a hot melt film and a pressure sensitive adhesive.

In addition to eliminating materials and reducing processing time and/or steps, there are also aesthetic and functional advantages with the finished flocked product as well. The finished flock products having a silicone adhesive are generally softer to the touch, more abrasion resistance, more strongly adhesively bond, thinner and more elegant. The flock products of the prior are thicker, have cut edges show some of the thick white latex adhesive. The thinner printed silicone adhesive layer show less of cut edge than the more thickly printed latex adhesive edges.

Some embodiments can include a process comprising the steps of: placing thermoplastic hot melt adhesive film, with a paper carrier, onto the vacuum palette of a multicolor carousel flocking machine; screen printing a silicone adhesive onto the hot melt film; flocking each color of the image one-by-one into the silicone adhesive; applying thermal energy to catalyze (polymerize) the silicone adhesive; vacuum cleaning any excess flock fibers away; laser cutting out each images, “weeding” and discarding the unwanted pieces outside and/or within the design; and removing the pieces, packing, and shipping to customers. Customers can place the flock product directly onto the item being decorated and then heat press them directly to permanently fix in place (no need for transfer carrier film, flock will not matt down due to extremely high melt point of silicone). The silicone adhesive lends itself uniquely well to the manufacture of such products, to which heat is directly applied to fix it onto the final substrate, without risk of one or more of flock fibers matting down as normal (latex) flock adhesive becomes tacky, multi-color direct flocking and laser cutting. Moreover, the silicone adhesive process can eliminate one or more of the following from the current water-based adhesive process: the need for a carrier film, the need for a release adhesive, the need to remove water for printed adhesive layer; the need for a hot-melt powder, the need to brush and/or clean away of any excess powder; the need to bake at high temperatures and greater periods of time to cure the adhesive; and the need to cut pieces out of the transfer sheet. The silicone adhesive formulations can be more quickly polymerized, generally in matter of few seconds rather than minutes. Commonly, the process of the prior art requires an hour or even more to remove the water from the latex before baking to cure the adhesive. Moreover, the silicone-based flock product can be immediately brushed after curing to remove any excess flock.

This silicone direct flock technology lends itself to graphic designs that are one contiguous piece and/or “patches” of any shape that can be laser cut, such as without limitation contiguous and/or images (products) with separate pieces, held together by an added carrier film and/or paper media. These direct flock contiguous and/or images (products) with separate pieces are substantially different from the direct flocking of patches or appliqués on garments by at least the use of continuous carrier film and/or paper media. It can also be applied to essentially any substrate that will not poison the catalyst, such as without limitation rubber, hot-melt adhesives, polyesters, polycarbonates, woven textiles, knitted textile, non-woven textiles, and mixed media substrates.

Some embodiments can include a process having the steps of: printing a silicone adhesive film onto a pressure sensitive adhesive coated carrier sheet; direct flocking of the printed silicone adhesive film to form a multicolored flock image; polymerization of printed silicone adhesive; vacuum cleaning of the flock layer; and laser cutting of flock product.

Some embodiments of the present disclosure are to a flocked product having a flock layer having a plurality of flock fibers, a thermo-adhesive layer, and a silicone adhesive layer positioned between the thermo-adhesive and the flock layer. The silicone adhesive layer can have a catalyst, a polysiloxane, polyvinyl siloxane, a rheology modifier. The catalyst can be platinum-containing catalyst. The thermo-adhesive layer can be one of a thermoplastic adhesive, a thermoset adhesive, or combination of a thermoplastic and thermoset adhesives. The polyvinyl siloxane can have one or more of vinyl functionalities. The polyvinyl siloxane can be selected from the group consisting essential of methylvinylsiloxane, methylvinylsiloxane, vinylsiloxane, (dimethylvinyl-terminated)dimethylsiloxane, (vinyldimethyl-terminated)siloxane, octamethylcyclotetrasilocane,(vinylphenylmethyl-terminated) dimethyl siloxane, (divinylmethyl-terminated) dimethyl siloxane, vinyldimethyl siloxane, (cyclicvinylemethyl) dimethyl siloxane, vinylmethylcyclosiloxane, trifluoropropylmethylcyclosiloxane, methyhyrdrocyclosiloxane, hexamethyldisiloxane, divinyltetramethylsiloxane, and tetramethyldisiloxane. The polysiloxane can be selected from the group consisting essentially of polyalkylsiloxane, polydialkylsiloxane, polydimethylsiloxane, octamethylcyclotetrasiloxane, methyloctadecyl siloxane, dimethylsiloxane, methyltetradecylsiloxane, docdecylsiloxane, tetradecylsiloxane, methylhexadecylsiloxane, hydrosiloxane, silanol-terminated dimethylsiloxane, hexamethylcycoltrisiloane, decamethylcyclopentasiloxane, octaphenylcyclotetrasiloxane, diphenylsilediol, trimethyltriphenylcyclotrisiloxane, and methyl-3,3,3-trifluoroproplysiloxane.

The rheology modifier can be fumed silica. The silicone adhesive layer can further have a coupling agent. The coupling agent can be selected from the group consisting essentially of an organosilicone coupling agent, organotitanium coupling agent, or a combination of oranganosilicone and organotitanium coupling agents. The orangosilicone coupling can have the general structure of Y—R—Si—(—X)₃. The organotitanium coupling agent can have the general structure of the Y—R—Ti—(—X)₃. Y generally denotes a functional group selected from the group consisting essentially of vinyl and epoxy, amino group. X can be selected from the group consisting essentially of chlorine, alkoxy, and acetoxy group.

Some embodiments of the present disclosure include a method of making the flock product having the steps of providing the thermo-adhesive layer, contacting a silicone adhesive with the thermo-adhesive layer, and contacting flock fibers with the silicone adhesive layer, wherein the contacting of the flock fibers with the silicone adhesive layer comprises an electrostatic flocking process. The step of contacting the silicone adhesive with the thermo-adhesive layer can include screen printing the silicone adhesive layer on the thermo-adhesive layer.

Some embodiments of the present disclosure include a flocked product having a silicone adhesive layer, a flock layer having a plurality of flock fibers, and a release sheet. The silicone adhesive layer can be positioned between the flock layer and release sheet. The silicone adhesive can be adhered to the release sheet and flock layer. The silicone adhesive layer can have a catalyst, a polysiloxane, polyvinyl siloxane, a rheology modifier. The flock layer can have a plurality of fibers having opposing first and second ends, wherein the second ends of flock fibers are adhered to silicone adhesive layer. The carrier sheet can have a pressure sensitive adhesive. The pressure sensitive adhesive can be positioned between the carrier sheet and the flock layer. The first ends of the flock fibers are generally adhered to the pressure sensitive adhesive. In some embodiments, the flocked can also have a thermo-adhesive layer. The first ends of flock fibers are generally adhered to the thermo-adhesive layer. The catalyst can be platinum-containing catalyst. The thermo-adhesive layer can be one of a thermoplastic adhesive, a thermoset adhesive, or combination of a thermoplastic and thermoset adhesives. The polyvinyl siloxane can have one or more of vinyl functionalities. The polyvinyl siloxane can be selected from the group consisting essential of methylvinylsiloxane, methylvinylsiloxane, vinylsiloxane, (dimethylvinyl-terminated)dimethylsiloxane, (vinyldimethyl-terminated)siloxane, octamethylcyclotetrasilocane, (vinylphenylmethyl-terminated) dimethylsiloxane, (divinylmethyl-terminated) dimethyl siloxane, vinyldimethyl siloxane, (cyclicvinylemethyl) dimethyl siloxane, vinylmethylcyclosiloxane, trifluoropropylmethylcyclosiloxane, methyhyrdrocyclosiloxane, hexamethyldisiloxane, divinyltetramethylsiloxane, and tetramethyldisiloxane. The polysiloxane can be selected from the group consisting essentially of polyalkylsiloxane, polydialkylsiloxane, polydimethylsiloxane,octamethylcyclotetrasiloxane, methyloctadecyl siloxane, dimethylsiloxane, methyltetradecylsiloxane, docdecylsiloxane, tetradecylsiloxane, methylhexadecylsiloxane, hydrosiloxane, silanol-terminated dimethylsiloxane, hexamethylcycoltrisiloane, decamethylcyclopentasiloxane, octaphenylcyclotetrasiloxane, diphenylsilediol, trimethyltriphenylcyclotrisiloxane, and methyl-3,3,3-trifluoroproplysiloxane. The rheology modifier can be fumed silica. The silicone adhesive layer can further have a coupling agent. The coupling agent can be selected from the group consisting essentially of an organgosilicone coupling agent, organotitanium coupling agent, or a combination of oranganosilicone and organotitanium coupling agents. The orangosilicone coupling can have the general structure of Y—R—Si—(—X)₃. The organotitanium coupling agent can have the general structure of the Y—R—Ti—(—X)₃. Y generally denotes a functional group selected from the group consisting essentially of vinyl and epoxy, amino group. X can be selected from the group consisting essentially of chlorine, alkoxy, and acetoxy group.

Some embodiments of the present disclosure include a method of making the flock product having the steps of providing a release sheet, contacting a silicone adhesive with the release sheet, and contacting flock fibers with the silicone adhesive layer. The contacting of the flock fibers with the silicone adhesive layer can be an electrostatic flocking process. The contacting of the silicone adhesive with the release sheet can be a screen printing the silicone adhesive layer on the release sheet.

Some embodiments of the present disclosure can include a flock transfer having a thermo-adhesive layer, a flock layer, a silicone adhesive layer positioned between the thermo-adhesive layer and the flock layer, and a carrier sheet. The flock layer can be positioned between the carrier sheet and the silicone adhesive layer. The flock layer can have a plurality of fibers having opposing first and second ends. The first ends of the flock fibers can be adhered to the carrier sheet. The second ends of flock fibers cam be adhered to silicone adhesive layer. The flock transfer can also include a pressure sensitive adhesive positioned between the flock layer and the carrier sheet. The first fiber ends can be in contact with and adhered to the pressure sensitive adhesive. The the thermo-adhesive layer can be one of a thermoplastic adhesive, a thermoset adhesive, or combination of a thermoplastic and thermoset adhesives. The polyvinyl siloxane can have one or more of vinyl functionalities. The polyvinyl siloxane can be selected from the group consisting essential of methylvinylsiloxane, methylvinylsiloxane, vinylsiloxane, (dimethylvinyl-terminated)dimethylsiloxane, (vinyldimethyl-terminated) siloxane, octamethylcyclotetrasilocane, (vinylphenylmethyl-terminated)dimethylsiloxane, (divinylmethyl-terminated) dimethyl siloxane, vinyldimethyl siloxane, (cyclicvinylemethyl) dimethyl siloxane, vinylmethylcyclosiloxane, trifluoropropylmethylcyclosiloxane, methyhyrdrocyclosiloxane, hexamethyldisiloxane, divinyltetramethylsiloxane, and tetramethyldisiloxane. The polysiloxane can be selected from the group consisting essentially of polyalkylsiloxane, polydialkylsiloxane, polydimethylsiloxane, octamethylcyclotetrasiloxane, methyloctadecylsiloxane, dimethylsiloxane, methyltetradecylsiloxane, docdecylsiloxane, tetradecylsiloxane, methylhexadecylsiloxane, hydrosiloxane, silanol-terminated dimethylsiloxane, hexamethylcycoltrisiloane, decamethylcyclopentasiloxane, octaphenylcyclotetrasiloxane, diphenylsilediol, trimethyltriphenylcyclotrisiloxane, and methyl-3,3,3-trifluoroproplysiloxane. The rheology modifier can be fumed silica. The silicone adhesive layer can further have a coupling agent. The coupling agent can be selected from the group consisting essentially of an organosilicone coupling agent, organotitanium coupling agent, or a combination of oranganosilicone and organotitanium coupling agents. The orangosilicone coupling can have the general structure of Y—R—Si—(—X)₃. The organotitanium coupling agent can have the general structure of the Y—R—Ti—(—X)₃. Y generally denotes a functional group selected from the group consisting essentially of vinyl and epoxy, amino group. X can be selected from the group consisting essentially of chlorine, alkoxy, and acetoxy group.

Some embodiments of the present disclosure include a method of making a flock transfer having the steps of providing s release sheet, contacting the flock fibers the release sheet contacting a silicone adhesive with the flock fibers, and contacting a thermo-adhesive with the free surface of the silicone adhesive. The contacting of the flock fibers with the release sheet can adhere the flock fibers to the release sheet.

These and other needs are addressed by the various embodiments and configurations of the present invention. The present invention can provide a number of advantages depending on the particular configuration. These and other advantages will be apparent from the disclosure of the invention(s) contained herein.

As used herein, “ at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The plurality of flock fibers may be formed from any natural or synthetic material. Synthetic material includes, without limitation, vinyl, rayons, nylons, polyamides, polyesters such as terephthalate polymers, such as poly(ethylene terephthalate) and poly(cyclohexylene-dimethylene terephthalate), and acrylic, and natural material includes cotton and wool. In one configuration, a conductive coating or finish is applied continuously or discontinuously over the exterior surface of the flock fibers to permit the flock fibers to retain an electrical charge.

The flock fibers may be pre-colored (yarn-dyed or spun dyed) or may be colored as part of the method of making described herein, such as by a dye sublimation transfer.

Preferably at least most, and even more preferably at least about 75%, and even more preferably all, of the flock fibers have a preferred denier of no more than about 60, more preferably no more than about 25, and even more preferably no more than about 5, with a range of from about 1.5 to about 3.5 being typical and have a titre ranging from about 0.5 to about 20 Dtex (from about 0.5 to about 20×10⁻⁷ Kg/m) and even more preferably from about 0.9 Dtex to about 6 Dtex. The length of at least most, and typically at least about 75%, of the flock fibers is preferably no more than about 4 mm, more preferably no more than about 2 mm, and even more preferably no more than about 1 mm, with a range of from about 0.3 to about 3.5 mm being typical. The flock fiber placement density relative to the surface area of the flocked portion (on which the flock is deposited) of the flocked product is preferably about 50% fibers/in², even more preferably at least about 60% fibers/in², and even more preferably at least about 70% fibers/in² of the flocked surface area.

“Polymer”, “polymeric”, or “polymer composition” generally refers to a molecule comprising a plurality of repeating chemical groups, typically referred to as monomers. Polymers include man-made polymers, natural polymers and mixtures thereof. Polymers are often characterized by high molecular masses. Useful polymers include organic polymers and inorganic polymers both of which may be in amorphous, semi amorphous, crystalline, partially crystalline states, or combinations thereof. Polymers may comprise monomers having the same chemical composition or may comprise a plurality of monomers having different chemical compositions, such as a copolymer. Cross-linked polymers have linked monomer chains. Useful polymers include but are not limited to plastics, elastomers, thermoplastic elastomers, elastoplastics, thermosets, thermoplastics and acrylates. Exemplary polymers include but are not limited to acetal polymers, biodegradable polymers, cellulosic polymers, epoxies, fluoropolymers, polyolefins, polystyrenes, polyvinyls, polyacrylics, polyhalo-olefins, polydienes, polyoxides/esthers/acetals, polysulfides, polyesters/thioesters, polyamides/thioamides, polyurethanes/thiourethanes, polyureas/thioureas, polyimides/thioimides, polyanhydrides/thianhydrides, polycarbonates/thiocarbonates, polyimines, polysiloxanes/silanes, polyphosphazenes, polyketones/thioketones, polysulfones/sulfoxides/sulfonates/sulfoamides, polyphylenes, nylons, polyacrylonitrile polymers, polyamide, imide polymers, polyimides, polyarylates, polybenzimidazole, polybutylene, polycarbonate, polyesters, polyetherimide, polyethylene, polyethylene copolymers and modified polyethylenes, polyketones, poly(methyl methacrylate), polymethylpentene, polyphenylene oxides and polyphenylene sulfides, polyphthalamide, polypropylene, polyvinyls, polyurethanes, natural and synthetic rubber, silicones, styrenic resins, sulfone based resins, vinyl based resins and any combinations of these.

A “metalized material” generally refers to one or more of a polymeric composition containing metalized particles, a polymeric composition having a metalized coating, a polymeric composition having a metalized appearance, a metal-containing composition, and a combination and/or mixture thereof. The metalized material may comprise a molded polyurethane or silicone. Typically, the metalized material comprises molded polyurethane formed by high-frequency molding and/or shaping processes. More typically, the metalized material comprises molded metal-containing polyurethane formed by high-frequency molding and/or shaping processes. The high frequency molding process is commonly a radio frequency molding process. The molded polyurethane may have a single metallic hue. The metal may be any metal. Generally, the metal is silver, nickel, aluminum, or alloys and combinations thereof. The metal may be encapsulated and/or dispersed in the polymeric material. The metal may be coated to provide for additional and/or different hues. For example, the metal can be coated with yellow hue to provide for a gold look, or dark orange for copper look. Commonly, the metal may be encapsulated and/or dispersed in the polyurethane. While not wanting to be limited by example, the metal may be encapsulated and/or dispersed between two polymeric film layers. The metalized material may or may not include an adhesive layer. The metalized material typically has a metallic surface or metallic-like appearing surface and an opposing surface. The opposing surface may or may not include the adhesive layer. The adhesive layer can be in the form of an adhesive film layer. The metallic-appearing surface is commonly in the form of three-dimensional surface. The three-dimensional surface is formed during the high frequency molding process. Furthermore, edges of the metalized material can be formed during the molding process. That is, the edges may be formed using a combination of high frequency energy and/or heat. Furthermore, the edges may be formed during the molding process by the mold die, specifically by the edge of the mold die and the pressure applied during the molding process. The molding process may or may not include welding a textile base to metalized material. Commonly, the metalized material is provided without a textile base. However, when provided with a textile base, the textile base is part of the metalized material. That is, the textile base of the metalized material is not a decorative element as used herein, other than that of the metalized material the textile base is molded thereto. The high frequency molding cannot cut through flock fibers, such as nylon flock fibers, nor through typical textile materials such as polyester-containing textile materials. More specifically, the high frequency molding process cannot cut through polymeric materials having a melting point greater than nylon and/or polyester. Even more specifically, the textile base has a melt temperature of commonly no more than about 190 degrees Celsius, more commonly no more than about 180 degrees Celsius, even more commonly no more than about 170 degrees Celsius. The metalized material can be one or more of pliable, soft and washable. More specifically, the metalized material can be laundered with clothing. The metalized material can be fabricated to resemble a metallic badge, such as, a police officer's badge, a fire department badge, a federal agent's badge or such.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

Any drawings in the attached are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples. Further features and advantages will become apparent from the following, more detailed, description of the various embodiments of the invention(s), as illustrated by the drawings referenced below.

FIG. 1 depicts a flock product according to the prior art;

FIG. 2 depicts another flock product according to the prior art

FIG. 2 depicts a process for making a flock product according to some embodiments of the present disclosure;

FIG. 3 depicts a flock product according to some embodiments of the present disclosure;

FIG. 4 depicts a flock product according to some embodiments of the present disclosure;

FIG. 5 depicts a process for making a flock product according to some embodiments of the present disclosure;

FIG. 6 depicts a flock product made according to the process of FIG. 5;

FIG. 7 depicts a process for making a flock product according to some embodiments of the present disclosure;

FIG. 8 depicts a flock product made according to the process of FIG. 7;

FIG. 9 depicts a process for making a flock transfer according to some embodiments of the present disclosure;

FIG. 10 depicts a flock transfer made according to the process of FIG. 9;

FIG. 11 depicts a Gaussian distribution having various t values; and

FIG. 12 depicts a process for making flock products according to some embodiments of the present disclosure.

### DETAILED DESCRIPTION

In some embodiments, the flocking adhesive comprises a silicone adhesive. In some embodiments, the flocking adhesive is a silicone adhesive. The silicone adhesive can have a higher melt point compared to a latex adhesive. Moreover, flock fibers adhered to a silicone adhesive tend be less, or not at all, matted down due to the silicone adhesive than the latex adhesives of the prior art. As such, the flock fibers are less inclined, if not at all, to be matted down in the silicone adhesive when compared to a non-silicone adhesive, such as a hot melt adhesive and/or latex adhesive. Furthermore, the flock fibers are less inclined, if not at all, to be matted down around the edges of the adhesive film, thereby, having a cleaner more defined flocked product edge. Silicone adhesives generally heat cure and/or thermally set more quickly than the typical prior flock latex and/or hot melt adhesives. The shorter silicone adhesive cure and/or thermal set times allow for one or more of increased production and greater dimensional stability of flocked product compared to the flocked products of prior art based on latex and/or hot melt adhesive. Dimensional stability of flocked products having the silicone adhesives described herein can be due to any one or more of little or no shrinkage of the silicone adhesive during the curing process. Furthermore, greater dimensional stability of the flocked products having a silicone adhesive can also enable more precise cutting of the resulting flocked product.

It has found that silicone adhesives generally have a greater adhesion to the flock fibers than one or more of the conventional flock latex and hot melt adhesives. This greater adhesion of the flock fibers results in the need to embed less of the flock fiber into the adhesive film. Hence, a greater percent of the flock fiber extends above the silicone adhesive film. A flocked product having a greater percent of the flock fiber extends above the adhesive film can have one or more of a softer feel and a plusher feel can be obtained.

Conventional latex flock adhesives comprise an aqueous emulsion as such, the curing process for an aqueous based adhesive includes removal of most, if not essentially all, of the water prior to curing of the adhesive. The removal of the water increases production time. Inclusion of water within the cured adhesive can result in cured adhesive with a decreased adhesive strength, compared to cured adhesive substantially lacking any retained water. Furthermore, a thicker printed latex film is generally needed, compared to water-free adhesive film, for the same thickness of the cured adhesive film. In general, a printed aqueous latex film is about at least twice as thick as printed silicone adhesive film.

The silicone adhesive generally comprises a polymeric material comprising one or more of vinyl terminated polyalkylsiloxane and vinyl terminated polyarlysiloxane and one or more of a polyalkyl siloxane and polyaryl siloxane. The polyalkly and/or polyaryl siloxanes are generally silyl terminated.

Typically, the vinyl polyalkyl siloxane and polyaryl siloxane can comprise one or more of vinyl functionality, methylvinylsiloxane, methylvinylsiloxane, vinylsiloxane, (dimethylvinyl-terminated) dimethylsiloxane, (vinyldimethyl-terminated) siloxane, octamethylcyclotetrasilocane, (vinylphenylmethyl-terminated) dimethylsiloxane, (divinylmethyl-terminated) dimethylsiloxane, vinyldimethylsiloxane, (cyclicvinylemethyl)dimethylsiloxane, vinylmethylcyclosiloxane, trifluoropropylmethylcyclosiloxane, methyhyrdrocyclosiloxane, hexamethyldisiloxane, divinyltetramethylsiloxane, and tetramethyldisiloxane.

The average molecular weights of the vinyl terminated polyalkylsiloxane and vinyl terminated polyarlysiloxane are commonly from about 750 daltons to about 50,000 daltons. The number of repeating alkyl/aryl units of —[—SiR₂O—]— are typically from about 10 to about 850. The polyalkyl and/or polyaryl siloxanes can have one or more terminal vinyl entities. The number of vinyl entities per polyalkyl and/or polyaryl siloxane chain is usually from about 1 to about 5, more typically from about 1 to 4, even more typically from about 2 to about 4, yet even more typically from about 2 to about 3. A non-limiting example of a vinyl terminated polyalkyl siloxane is vinyl terminated poly(dimethylsioxane),

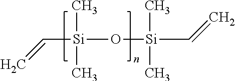

Typically, the silicone adhesive formulation comprises a catalyst, one or more of vinyl terminated polyalkylsiloxane and vinyl terminated polyarlysiloxane, and one or more of a polyalkyl siloxane and polyaryl siloxane. The silicone adhesive formulation can also include a rheology modifier. Typically, the rheology modifier is premixed with the catalyst and the one or more of a polyalkyl siloxane and polyaryl siloxane. The siloxane can comprise without limitation one or more of a polysiloxne, a polyalkyl siloxane, polydialkylsiloxane, polydimethylsiloxane, octamethylcyclotetrasiloxane, methyloctadecyl siloxane, dimethylsiloxane, methyltetradecylsiloxane, docdecylsiloxane, tetradecylsiloxane, methylhexadecylsiloxane, hydrosiloxane, silanol-terminated dimethylsiloxane, hexamethylcycoltrisiloane, decamethylcyclopentasiloxane, octaphenylcyclotetrasiloxane, diphenylsilediol, trimethyltriphenylcyclotrisiloxane, and methyl-3,3,3-trifluoroproplysiloxane.

The average molecular weights of the polyalkylsiloxane and polyarlysiloxane are commonly from about 750 daltons to about 50,000 daltons. The number of repeating alkyl/aryl units of —[—SiR₂O—]— are typically form about 10 to about 850. A non-limiting example of a polyalkyl siloxane is trimethylsilyl terminated poly(dimethylsioxane-co-methylhydrosiloxane), (II):

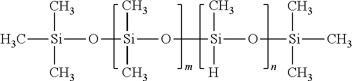

In some embodiments, the silicone adhesive prior to curing can comprise one or more of vinyl terminated polyalkylsiloxane and vinyl terminated polyarlysiloxane and one or more of a polyalkyl siloxane and polyaryl siloxane, a catalyst, and one or more of xylene, octamethylcyclotetrasiloxane, a linear silicone, cyclic silicone, hhdrosilicone, and octanol. The catalyst is generally premixed with the silicone base. It can be appreciated that in some embodiments, the silicone adhesive prior to curing can also comprise a rheology modifier.

The ratio of one or more of vinyl terminated polyalkylsiloxane and vinyl terminated polyarlysiloxane to the one or more of a polyalkyl siloxane and polyaryl siloxane in the silicone adhesive can commonly be one of about 75:1, more commonly be about 70:1, even more commonly be about 65:1, yet even more commonly be about 60:1, still yet even more commonly be about 55:1, still yet even more commonly be about 50:1, still yet even more commonly be about 45:1, still yet even more commonly be about 40:1, still yet even more commonly be about 35:1, still yet even more commonly be about 30:1, still yet even more commonly be about 25:1, still yet even more commonly be about 20:1, still yet even more commonly be about 15:1, still yet even more commonly be about 10:1, still yet even more commonly be about 7.5:1, still yet even more commonly be about 5:1, still yet even more commonly be about 2.5:1, still yet even more commonly be about 2:1, still yet even more commonly be about 1.9:1, still yet even more commonly be about 1.8:1, still yet even more commonly be about 1.7:1, still yet even more commonly be about 1.6:1, still yet even more commonly be about 1.5:1, still yet even more commonly be about 1.4:1, still yet even more commonly be about 1.3:1, still yet even more commonly be about 1.2:1, still yet even more commonly be about 1.1:1, still yet even more commonly be about 1:1, still yet even more commonly be about 1:1.1, still yet even more commonly be about 1:1.2, still yet even more commonly be about 1:1.3, still yet even more commonly be about 1:1.4, still yet even more commonly be about 1:1.5, still yet even more commonly be about 1:1.6, still yet even more commonly be about 1:1.7, still yet even more commonly be about 1:1.8, still yet even more commonly be about 1:1.9, still yet even more commonly be about 1:2, still yet even more commonly be about 1:2.5, still yet even more commonly be about 1:5, still yet even more commonly be about 1:7.5, still yet even more commonly be about 1:10, still yet even more commonly be about 1:15, still yet even more commonly be about 1:20, still yet even more commonly be about 1:25, still yet even more commonly be about 1:30, still yet even more commonly be about 1:35, still yet even more commonly be about 1:40, still yet even more commonly be about 1:45, still yet even more commonly be about 1:50, still yet even more commonly be about 1:55, still yet even more commonly be about 1:60, still yet even more commonly be about 1:65, still yet even more commonly be about 1:70, yet still even more commonly be about 1:75.

The silicone adhesive layer 230 can comprise one or more of a homopolymer, a copolymer, and a polymeric alloy. Generally, the silicone adhesive layer 230 comprises one or more of a siloxane and vinyl siloxane. More generally, the silicone adhesive layer 230 comprises one or more of a siloxane and vinyl siloxane polymerized and/or alloyed with one or more of a polyolefin, polystyrene, polyvinyl, polyacrylic, polyhalo-olefin, polydiene, polyoxide, polyesther, polyacetal, polysulfide, polythioester, polyamide, polythioamide, polyurethane, polythiourethane, polyurea, polythiourea, polyimide, polythioimide, polyanhydride, polythianhydride, polycarbonate, polythiocarbonate, polyimine, polyphosphazene, polyketone, polythioketone, polysulfone, polysulfoxide, polysulfonate, polysulfoamide, and polyphylene. Even more generally, the silicone adhesive layer 230 comprises one or more of a siloxane and vinly siloxane polymerized with, and alloyed with one or more of a polyolefin, polystyrene, polyvinyl, polyacrylic, polyhalo-olefin, polydiene, polyoxide, polyesther, polyacetal, polyanhydride, polycarbonate, polyphosphazene, polyketone, and polyphylene.

In some embodiments, the silicone adhesive layer 230 comprises one or more of a siloxane and vinyl siloxane polymerized and/or alloyed with one or more of acrylonitrile butadiene styrene, acrylic (PMMA), celluloid, cellulose acetate, cyclo-olefin copolymer, ethylene-vinyl acetate (EVA), ethylene vinyl alcohol (EVOH), fluoroplastic (PTFE, FEP, PFA, CTFE, ECTFE, and/or ETFE), ionomer, liquid crystal polymer (LCP), polyacetal (POM and/or acetal), polyacrylate (acrylic), polyacrylonitrile (PAN or acrylonitrile), polyamide (PA or nylon), polyamide-imide (PAI), polyaryletherketone (PAEK and/or ketone), polybutadiene (PBD), polybutylene (PB), polybutylene terphthalate (PBT), polycaprolactone (PCL), polychlorotrifluoroethylene (PCTFE), polyethylene terephthalate (PET), polycycloheylene dimethylene terephthalate (PCT), polycarbonate (PC), polyhydroxylalkanoate (PHA), polyketone (PK), polyester, polyethylene(PE), polyetherketoneketone (PEKK), polyetherimide (PEI), polyethersulfone (PES), polysulfone, polyethlenechloriate (PEC), polyimide, polyacetic acid (PLA), polymethylpentene (PMP), polyphenylene oxide (PPO), polyphylene sulfide (PPS), polyphthalamide (PPA), polypropylen (PP), polystyrene (PS), polsulfone (PSU), polytrimethylen terphthalate (PTT), polyurethane (PU), polyvinyl acetate (PVA), polyvinyl chloride (PVC), polyvinylidene chloride (PVDC), and styrene-acrylonitrile (SAN).

In some embodiments, the silicone adhesive layer 230 comprises one or more of a siloxane and vinyl siloxane polymerized and/or alloyed with one or more of acrylonitrile butadiene styrene, acrylic (PMMA), celluloid, cellulose acetate, cyclo-olefin copolymer, ethylene-vinyl acetate (EVA), ethylene vinyl alcohol (EVOH), fluoroplastic (PTFE, FEP, PFA, CTFE, ECTFE, and/or ETFE), ionomer, liquid crystal polymer (LCP), polyacetal (POM and/or acetal), polyacrylate (acrylic), polyaryletherketone (PAEK and/or ketone), polybutadiene (PBD), polybutylene (PB), polybutylene terphthalate (PBT), polycaprolactone (PCL), polychlorotrifluoroethylene (PCTFE), polyethylene terephthalate (PET), polycycloheylene dimethylene terephthalate (PCT), polycarbonate (PC), polyhydroxylalkanoate (PHA), polyketone (PK), polyester, polyethylene(PE), polyetherketoneketone (PEKK), polyethlenechloriate (PEC), polyacetic acid (PLA), polymethylpentene (PMP), polyphenylene oxide (PPO), polystyrene (PS), polytrimethylen terphthalate (PTT), polyvinyl acetate (PVA), polyvinyl chloride (PVC), and polyvinylidene chloride (PVDC).

In some embodiments, the silicone adhesive can include a coupling agent. In some embodiments, the one or more of vinyl terminated polyalkylsiloxane, vinyl terminated polyarlysiloxane, polyalkyl siloxane, and polyaryl siloxane can comprise a coupling agent. The coupling agent can comprise one or more of organosilicone coupling agents, organotitanium coupling agents, or a combination of oranganosilicone and organotitanium coupling agents. A coupling agent generally has two functional groups with different reactivity. The general structure of the coupling agents is as follows:

Y—R—Si—(—X)₃; or

Y—R—Ti—(—X)₃.

Where Y denotes a functional group that links with organic materials, e.g. vinyl, epoxy, amino group and so on. X includes chlorine, alkoxy, and acetoxy group. It is believed that the Y functional group can link with one or more of the flock fibers, a thermoplastic adhesive, a thermoset adhesive, a hot melt adhesive, a substrate, and such. It is further believed that the X group reacts, when catalyzed by one or more of the platinum and peroxide catalyst, with one or more of silicone adhesive and silicone base. In other words, it is believed that the coupling agent further promotes and/or assists in the adhesion of the silicone adhesive layer to one or more of flock fibers, a thermoplastic adhesive, a thermoset adhesive, a hot melt adhesive, a substrate, and such. Non-limiting examples of silicone-containing coupling agents are: 3-(trimethoxysilyl)propyl acrylate, 3-[diethoxy(methyl)silyl]propyl methacrylate, 3-(trimethoxysilyl) propyl methacrylate, 3-[tris(trimethylsilyloxy)silyl]propyl methacrylate, 3-[dimethoxy(methyl)silyl]propyl methacrylate, 3-(methoxydimethylsilyl)propyl acrylate, 3-(triethoxysilyl)propyl methacrylate, 3-(triallylsilyl)propyl acrylate, 3-(triallylsilyl)propyl methacrylate, amyltrichlorosilane, butyltrichlorosilane, tert-butyldimethylchlorosilane, butylchlorodimethylsilane, 1,2-bis(triethoxysilyl)ethane, chlorotrimethylsilane, cyclohexyltrichlorosilane, chloro(decyl)dimethylsilane, chloro(dodecyl) dimethylsilane, cyclohexyltrimethoxysilane, chloro(hexyl)dimethylsilane, dimethylethylchlorosilane, decyltrichlorosilane, dodecyltrichlorosilane, dodecyltriethoxysilane, dimethyloctadecylchlorosilane, chlorodimethylpropylsilane, dimethylisopropylchlorosilane, dimethyl-n-octylchlorosilane, chlorodiethylisopropylsilane, dodecyltrimethoxysilane, decyltriethoxysilane, ethyltrichlorosilane, triethoxyethylsilane, ethyltrimethoxysilane, trichlorohexylsilane, hexyltrimethoxysilane, hexyltriethoxysilane, hexadecyltrimethoxysilane, 1,1,1,3,5,5,5-heptamethyl-3-[(trimethylsilyl)oxy)trisiloxane)], isobutyltrichlorosilane, trichloro(methyl)silane, triethoxymethylsilane, trimethoxy(methyl)silane, methoxy(dimethyl)octadecylsilane, trichlorooctadecylsilane, octadecyltriethoxysilane, n-octyltrichlorosilane, triethoxy-n-octylsilane, octadecyltrimethoxysilane, trichloro(propyl)silane, chlorotriethylsilane, trichlorotetradecylsilane, triisopropylsilyl chloride, trimethoxy(propyl)silane, chloro(dimethyl)thexylsilane, hexyltrichlorosilane, triethoxy(propyl)silane, trimethoxy-n-octylsilane, benzylchlorodimethylsilane, benzyltriethoxysilane, chlorodimethyl(3-phenylpropyl)silane, chlorodimethylphenylsilane, dimethoxymethylphenylsilane, diethoxy(methyl)phenylsilane, methoxy(dimethyl)octadecylsilane, phenyltrichlorosilane, triethoxyphenylsilane, trimethoxyphenylsilane, trimethoxy(p-tolyl)silane, trichloro(phenylethyl)silane, trichloro(3-phenylpropyl)silane, trichloro(6-phenylhexyl)silane, trimethoxy(2-phenylethyl)silane, trimethoxy(4-vinylphenyl)silane, 1-(trimethoxysilyl)naphthalene, trimethoxy(phenylethyl)silane (mixture of 1-phenylethyl- and 2-phenylethyl-), chlorodimethyl (3,3,4,4,5,5,6,6,7,7,8,8,8-tridecafluoro-n-octyl)silane, chlorodimethyl[3-(2,3,4,5,6-pentafluorophenyl)propyl]silane, dichloro(methyl)(3,3,3-trifluoropropyl)silane, dimethoxy(methyl)(3,3,3trifluoropropyl) silane, pentafluorophenyldimethylchlorosilane, pentafluorophenylethoxydimethylsilane, triethoxy-1H,1H,2H,2H-tridecafluoro-n-octylsilane, trichloro(1H,1H,2H,2H-tridecafluoro-n-octyl)silane, trichloro(1H,1H,2H,2H-heptadecafluorodecyl)silane, trimethoxy(3,3,3-trifluoropropyl)silane, triethoxy(1H,1H,2H,2H-nonafluorohexyl)silane, triethoxy-1H,1H,2H,2H-heptadecafluorodecylsilane, trimethoxy(1H,1H,2H,2H-heptadecafluorodecyl)silane, trimethoxy(1H,1H,2H,2H-nonafluorohexyl)silane, trichloro[3-(pentafluorophenyl)propyl]silane, triethoxy(pentafluorophenyl)silane, triethoxy[5,5,6,6,7,7,7-heptafluoro-4,4-bis(trifluoromethyl)heptyl]silane, trimethoxy (pentafluorophenyl)silane, trichloro(3,3,3-trifluoropropyl)silane, trimethoxy(1H,1H,2H,2H-tridecafluoro-n-octyl)silane, diethoxy(3-glycidyloxypropyl)methylsilane, 3-glycidyloxypropyltrimethoxysilane, 3-glycidyloxypropyl (dimethoxy)methylsilane, [8-(glycidyloxy)-n-octyl]trimethoxysilane, triethoxy(3-glycidyloxypropyl)silane, allyltriethoxysilane, allylchlorodimethylsilane, allyltrimethoxysilane, [bicyclo[2.2.1]hept-5-en-2-yl]triethoxysilane, chlorodimethylvinylsilane, diethoxymethylvinylsilane, dimethoxymethylvinylsilane, 1,1,1,5,5,5-hexamethyl-3-[(trimethylsilyl)oxy]-3-vinyltrisiloxane, trichlorovinylsilane, tinyltrimethoxysilane, triethoxyvinylsilane, dimethylethoxyvinylsilane, vinyltris(2-methoxyethoxy)silane, (11-azidoundecyl)trimethoxysilane, (bromomethyl)chlorodimethylsilane, chloro(chloromethyl) dimethylsilane, 3-trimethoxysilylpropyl chloride, 3-chloropropyltrichlorosilane, 3-chloropropyldimethoxymethylsilane, (3-cyanopropyl)dimethylchlorosilane, 2-cyanoethyltriethoxysilane, (chloromethyl)triethoxysilane, (chloromethyl) trimethoxysilane, (3-chloropropyl)diethoxy(methyl)silane, chloro(3-chloropropyl)dimethylsilane, 2-(3,4-epoxycyclohexyl)ethyltrimethoxysilane, tris[3-(trimethoxysilyl)propyl]isocyanurate, (3-mercaptopropyl)trimethoxysilane, 3-mercaptopropyl(dimethoxy)methylsilane, (3-mercaptopropyl)triethoxysilane, 2-propynyl[3-(triethoxysilyl)propyl]carbamate, 3-chloropropyltriethoxysilane, 3-isocyanatopropyl) trimethoxysilane, 1-[3-(triethoxysilyl)propyl]urea, N-[2-(N-vinylbenzylamino)ethyl]-3-aminopropyltrimethoxysilane hydrochloride, and titanium analogues thereof. In some embodiments the coupling agent is glycidoxypropyl trimethoxysilane. In some embodiments, the silicone base includes glycidoxypropyl trimethoxysilane.

The silicone adhesive general reacts with one or more of a coupling agent, flock fibers, a thermoplastic adhesive, a thermoset adhesive, a hot melt adhesive, and a substrate. The crosslinking reaction of the silicone base, coupling agent, flock fibers, a thermoplastic adhesive, a thermoset adhesive, a hot melt adhesive, and a substrate. The reaction of the one or more of the coupling agent, flock fibers, thermoplastic adhesive, thermoset adhesive, hot melt adhesive, and substrate with the silicone adhesive is generally one or more of an addition cure, condensation cure, peroxide cure, ultraviolet cure, electron-beam cure, and room temperature vulcanization cure. The reaction of the silicone adhesive with one or more of the coupling agent, flock fibers, thermoplastic adhesive, thermoset adhesive, hot melt adhesive, and substrate can be catalyzed by one or more of platinum catalyst, a zinc catalyst, and a peroxide catalyst.

In some embodiments, the one or more of vinyl terminated polyalkylsiloxane, vinyl terminated polyarlysiloxane, polyalkyl siloxane, and polyaryl siloxane can further comprise silica. Generally, the silica can be a rheology modifier for the one or more of vinyl terminated polyalkylsiloxane and vinyl terminated polyarlysiloxane and/or the one or more of a polyalkyl siloxane and polyaryl siloxane.

Typically, the silica comprises fumed silica. The fumed silica can comprise microscopic droplets of amorphous silica (SiO₂). The droplets of amorphous silica are generally fused into one or more of branched, chainlike, three-dimensional secondary particles. The secondary particles can agglomerate into tertiary particles. The fumed silica can be in the form of powder. The fumed silica powder commonly has a low bulk density and high surface area. Commonly, the fumed silica has a primary particle size from about 5 to about 50 nm. The fumed silica typically comprises non-porous particles. The fumed silica particles generally have a surface area from about 50 to about 600 m²/g. Typically, the fumed silica has a density from about 0.15 to about 0.2 g/cm³. When fumed silica is mixed with a liquid silicone adhesive, the fumed silica can increase the viscosity of the liquid silicone adhesive. Moreover, the addition of fumed silica to a liquid silicone adhesive can one or more of thicken, be a reinforcing filler, and be a thixotropic agent for the liquid silicone adhesive. In some embodiments, the fumed silica can be a hydrophilic fumed silica. In some embodiments, the fumed silica can be a hydrophobic fumed silica. The hydrophobic fumed silicas are generally chemically treated with one or more of silanes and siloxanes. The one or more siloxanes are chemically bonded to the silica. The hydrophobic fumed silicas are typically characterized, among other things, by a low moisture adsorption, excellent dispersibility, and their ability to adjust rheological behavior. In some embodiments, the fumed silica can be positively charged. In some embodiments, the fumed silica can be negatively charged. In some embodiments, the fumed silica can comprise a mixed oxide comprising SiO₂ and one or more of aluminum and titanium oxides, generally Al₂O₃ and TiO₂. In some embodiments, the fumed silica can be fumed Al₂O₃. In some embodiments, the fumed silica can be fumed TiO₂. In some embodiments, the fumed silica can comprise spherical particles with an average size of about 30 micrometers (or 30 millionths of a meter).

In some embodiments the silica can comprise one or more of dimethyl, methylvinyl siloxane and trimethysilyl treated silica, dimethylvinylated and trimethylated silica, dimethyl, methylvinyl siloxane and trimethylsilyl treated silica, hexamethyldisilizane treated silica, and trimethylated silica.

The silicone adhesive can commonly have one of from about 5 to about 35 wt % silica, more commonly from about 6 to about 34 wt % silica, even more commonly from about 7 to about 33 wt % silica, yet even more commonly from about 8 to about 32 wt % silica, still yet even more commonly from about 9 to about 31 wt % silica, still yet even more commonly from about 10 to about 30 wt % silica, still yet even more commonly from about 11 to about 29 wt % silica, still yet even more commonly from about 12 to about 27 wt % silica, still yet even more commonly from about 13 to about 25 wt % silica, still yet even more commonly from about 14 to about 24 wt % silica, still yet even more commonly from about 15 to about 23 wt % silica, or yet still even more commonly from about 16 to about 22 wt % silica.

The wt % silica in the silicone adhesive is believed to affect the printability of silicone adhesive. It is generally believed to affect the stinginess of silicone adhesive when the adhesive is screen printed.

Generally, the platinum catalyst is present in the silicone adhesive layer at a level from about 5 to about 300 ppm. In some embodiments, the platinum catalyst is present in the silicone adhesive layer at a level from about 5 to about 50 ppm. In some embodiments, the platinum catalyst is present in the silicone adhesive layer at a level from about 50 to about 150 ppm. In some embodiments, the platinum catalyst is present in the silicone adhesive layer at a level from about 150 to about 220 ppm.

Typically, the platinum catalyst is present in the silicone base at a level from about 5 to about 300 ppm. In some embodiments, the platinum catalyst is present in the silicone base at a level from about 5 to about 50 ppm. In some embodiments, the platinum catalyst is present in the silicone base at a level from about 50 to about 150 ppm. In some embodiments, the platinum catalyst is present in the silicone base at a level from about 150 to about 220 ppm.

Commonly, the platinum catalyst comprises a platinum vinylsiloxane complex. The platinum catalyst can be poisoned by one or more of amines, sulfur, chloride, epoxy, natural rubber, tin salts, mercaptans, amino compounds and polyvinylchloride.

In some embodiments, the catalyst can comprise a peroxide. The level of peroxide in one of the adhesive layer or in silicone base material can be from about 0.1 to about 1.5 wt %. The cure temperature when the adhesive is cured using a peroxide catalyst is typically from about 120 to about 170 degrees Celsius.

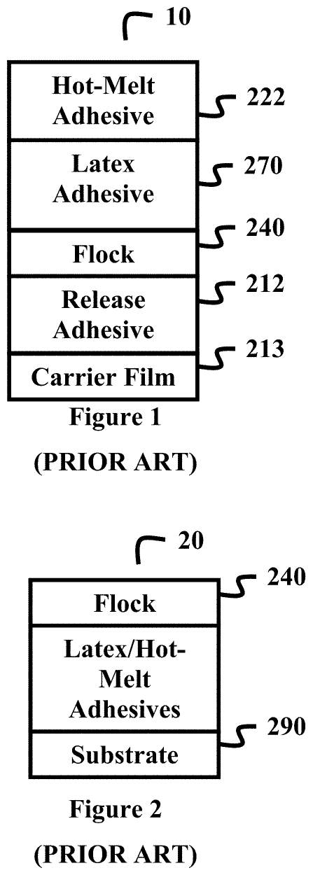

FIG. 1 depicts a flocked transfer 10 of the prior art. Flock transfers 10 of the prior art comprise a carrier sheet 213 having a release adhesive 212 positioned between the flock fibers 240 and the carrier sheet 213. The flock fibers have opposing first and second flock fiber ends. The first flock fiber ends are adhered to the carrier sheet 213 by the release adhesive 212. The second flock fiber ends embedded in a latex adhesive 270. The latex 270 is positioned between a hot melt adhesive 220 and the flock fibers 240.

FIG. 2 depicts a direct flocked product 20 of the prior art. Direct flocked products 20 of the prior art comprise an adhesive layer 275 positioned between a flock layer 240 and a substrate 290. The adhesive layer 275 can be one of a hot melt adhesive 220, a latex adhesive 270, or a combination thereof. For example, the adhesive layer can comprise first and second layers with one of the first or second layers position on top of other of the first and second layers, with the first layer comprising the latex adhesive 270 and the second layer comprising the hot melt adhesive 220.

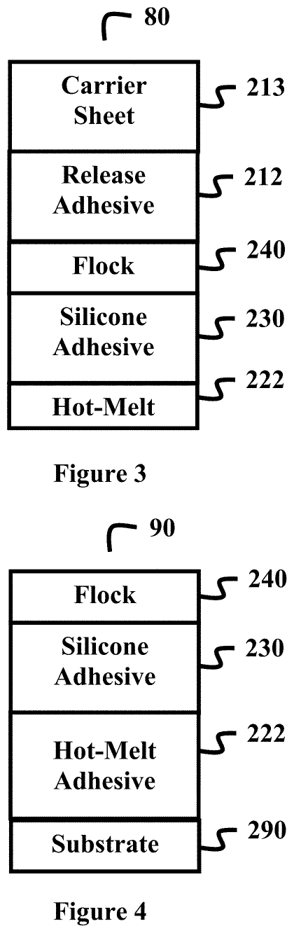

FIG. 3 depicts a direct flocked product 80 according to some embodiments of the present disclosure. Flocked product 80 can comprise a release adhesive 212 positioned between the flock fibers 240 and the carrier sheet 213. The flock transfer can comprise a plurality of flock fibers 240 adhered to a silicone adhesive layer 230. The flock fibers 240 have a flock fiber length 114 and opposing first 103 and second 104 fiber ends. The first flock fiber ends are adhered to the carrier sheet 213 by the release adhesive 212. The second flock fiber ends are adhered to a silicone adhesive 230. The silicone adhesive 230 is positioned between one of a hot-melt adhesive 222 and the flock fibers 240.

FIG. 4 depicts a direct flocked product 90 according to some embodiments of the present disclosure. Direct flock product 90 can comprise a silicone adhesive layer 230 positioned between flock fibers 240 and a substrate 290. The silicon adhesive layer 230 can further comprise a hot melt adhesive 222. In some embodiments, the hot melt adhesive 220 can be positioned between the flock fibers 240 and the silicone adhesive layer 230. In some embodiments, the hot melt adhesive 222 can be positioned between the substrate 290 and the silicone adhesive layer 230. In some embodiments, the silicone layer is positioned between the flock fiber layer 240 and the substrate 290 and is contact with each of the flock fiber layer 240 and the substrate 290.

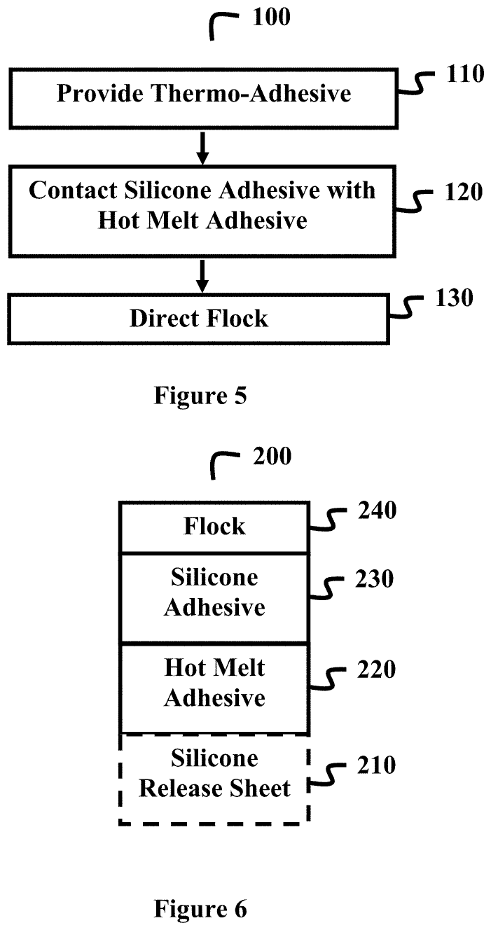

FIGS. 5 and 6 depict direct flocked product 200 and a method of making the same. FIG. 6 depicts the method of making the directed flocked product 200. The flocked product 200 can comprise a silicone adhesive layer 230 positioned between a thermo-adhesive layer 220. The thermo-adhesive layer can be one of thermoplastic adhesive, a thermoset adhesive or a combination of thermoplastic and thermoset adhesives. Some embodiments can include a release sheet 210 in contact with the thermo-adhesive layer 220. The thermo-adhesive layer 220 can be positioned between the release sheet 210 and the silicone adhesive layer 230. The release sheet 210 can be a silicone release sheet 210. The direct flocked product 200 can comprise a plurality of flock fibers 240 having a flock fiber length 114 and opposing first 103 and second 104 fiber ends. The second fiber ends are in contact with and adhered to the silicone adhesive layer 230. The flock layer 240 can comprise a plurality of flock fibers in contact with and adhered to the silicone adhesive layer 230. The silicone adhesive layer 230 is typically positioned between the flock layer 240 and the thermo-adhesive layer 220. Moreover, the silicone adhesive layer 230 is in contact with both the flock layer 240 and the thermo-adhesive layer 220. The thermo-adhesive layer 220 can be in some embodiments in contact with each of the silicone adhesive layer 230 and the release sheet 210. The flock layer 240 can comprise a plurality of flock fibers comprising substantially the same color or a plurality of flock fibers comprising some fibers having one color and the other fibers having another color. In some embodiments, the flock layer 240 comprises substantially a single color. In some embodiments, the flock layer 240 comprises two or more colors, with each of the flock fibers having one of the two or more colors.

The flock product 200 of FIG. 6 can be made by process 100 of FIG. 5. Process 100 typically includes: a step 110, providing a thermo-adhesive 220. The thermo-adhesive 220 may or may not be provided with a release sheet 2100. In step 120, a silicone adhesive 230 is applied to and/or contacting with the thermo-adhesive 220. Generally, step 120 includes screen-printing the silicone adhesive 220 on the thermo-adhesive 220. Typically, step 130 includes contacting and adhering flock fibers 240 to the silicone adhesive 230. Step 110 can include providing a release sheet having a thermo-adhesive layer on one side of the release sheet 210. The thermo-adhesive film layer has opposing first and second thermo-adhesive surfaces. Step 120 can include screen printing a silicone adhesive 230 onto a first surface of the thermo-adhesive layer 220. In step 130, flock fibers are contacted, in a direct flocking process, with the silicone adhesive layer 230. The direct flocking can include an electrostatic process of contacting the flock fibers with the silicone adhesive layer 230.

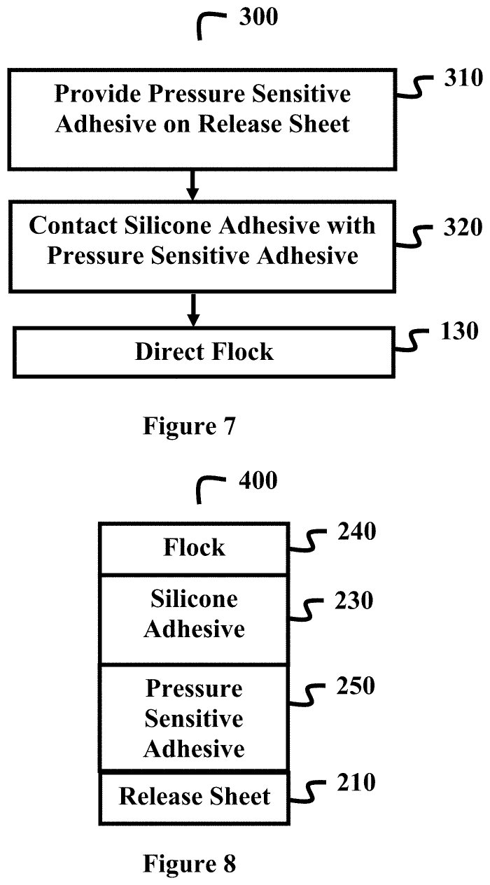

FIGS. 7 and 8 depict a flock product 400 and a method of making the same. FIG. 8 depicts flock product 400. The flock product 400 can comprise a flock layer 240, a silicone adhesive layer 230, a pressure sensitive adhesive layer 250, and a release sheet 210. The release sheet 210 can be a silicone release sheet. The flock product 400 can comprise a plurality of flock fibers 240 having a flock fiber length 114 and opposing first 103 and second 104 fiber ends. The second fiber ends are in contact with and adhered to the silicone adhesive layer 230. The flock layer 240 comprise a plurality of flock fibers in contact with and adhered to the silicone adhesive layer 230. The silicone adhesive layer 230 can be positioned between the flock layer 240 and the pressure sensitive adhesive layer 250. Moreover, the silicone adhesive layer 230 can be in contact with each of the flock layer 240 and the pressure sensitive adhesive layer 250. The pressure sensitive adhesive layer 250 can be positioned between the silicone adhesive layer 230 and the release sheet 210. The pressure sensitive adhesive layer 250 can be in contact with each of the silicone adhesive layer 230 and the release sheet 210. The flock layer 240 can comprise a plurality of flock fibers comprising substantially the same color or a plurality of flock fibers comprising some fibers having one color and the other fibers having another color. In some embodiments, the flock layer 240 comprises substantially a single color. In some embodiments, the flock layer 240 comprises two or more colors, with each of the flock fibers having one of the two or more colors.

The flock product 400 of FIG. 7 can be made by the process 300 depicted in FIG. 6. The process 300 typically includes: a step 310 of providing a pressure sensitive adhesive 250 positioned on a release sheet 220; a step 320 of contacting a silicone adhesive 230 with the pressure sensitive adhesive 250; and step 330 of contacting and/or adhering flock fibers 240 to the silicone adhesive 230. Step 310 can include providing a release sheet 220 having a pressure sensitive adhesive layer 250 on one side of the release sheet 210. Step 320 can include screen printing a silicone adhesive 230 onto a first surface of the pressure sensitive adhesive layer 250. The second pressure sensitive adhesive surface is in contact with the silicone release sheet 210. The first and second surfaces of the pressure sensitive adhesive layer 250 being in an opposing relationship. Step 330 can include direct flocking of the silicone adhesive layer. In step 330, flock fibers are contacted, in a direct flocking process, with the silicone adhesive layer 230. The direct flocking can include an electrostatic process of contacting the flock fibers with the silicone adhesive layer 230.

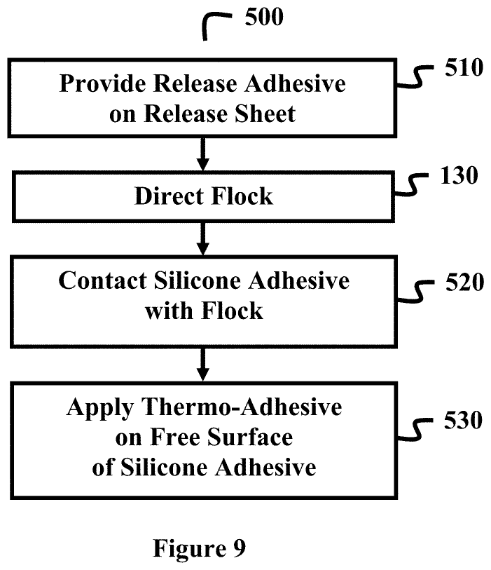

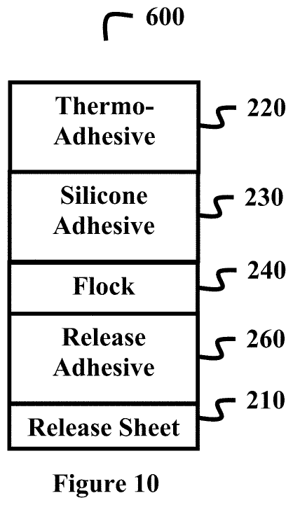

FIGS. 9 and 10 depict flock transfer 600 and a method of making the same. FIG. 10 depicts the flock transfer 600. The flock transfer 600 can comprise a thermo-adhesive layer 220, a silicone adhesive layer 230, a flock layer 240, a release adhesive layer 260, and a release sheet 210. The flock layer 240 comprise a plurality of flock fibers positioned between the silicone adhesive layer 230 and a release adhesive layer 260. The flock transfer 600 can comprise a plurality of flock fibers 240 having a flock fiber length 114 and opposing first 103 and second 104 fiber ends. The second fiber ends 104 are in contact with and adhered to the silicone adhesive layer 230. The first fiber ends 103 are in contact with and adhered to the release adhesive layer 260. The flock fibers 240 are in contact with the silicone adhesive layer 230 and the release adhesive layer 260. After curing of the silicone adhesive layer 230, the flock fibers 240 are more strongly adhesively bound to the silicone adhesive layer 230 than to the release adhesive layer 260. The release adhesive 260 is positioned between the flock layer 240 and the release sheet 210. Moreover, the release adhesive 260 is in contact with both the flock layer 240 and the release sheet 210. The silicone adhesive layer 230 is positioned between the thermo-adhesive layer 220 and the flock layer 240. Furthermore, the silicone adhesive layer 230 is in contact with both the thermo-adhesive layer 220 and the flock layer 240. The thermo-adhesive 220 can be one of a thermoplastic adhesive, a thermoset adhesive, or a combination of thermoplastic and thermoset adhesives. The flock layer 240 can comprise a plurality of flock fibers comprising substantially the same color or a plurality of flock fibers comprising some fibers having one color and the other fibers having another color. In some embodiments, the flock layer 240 comprises substantially a single color. In some embodiments, the flock layer 240 comprises two or more colors, with each of the flock fibers having one of the two or more colors. The first flock fiber ends in contact with and adhered to the silicone release sheet 210. The second flock fiber ends are in contact with and adhered to a silicone adhesive 230. The silicone adhesive 230 is positioned between thermo-adhesive 220 and the flock fibers 240.

The flock transfer 600 of FIG. 10 can be made by process 500 depicted in FIG. 9. Process 500 typically includes: a step 510 of providing a release adhesive 260 on a release sheet 210; a step 130 of contacting and/or adhering flock fibers 240 to the release adhesive 260; a step 520 of contacting a silicone adhesive 230 with the flock fibers 240; and step 530 of contacting a thermo-adhesive 220 on the free surface of the silicone adhesive 230. Step 510 can include providing a silicone release sheet having a release adhesive layer 260 on one side of the silicone release sheet 210. The release adhesive layer 260 can have opposing first and second release surfaces. Step 120 can include contacting and/or adhering the first ends of flock fibers to the release adhesive 260. The second ends of the flock fibers are in an opposing relationship with the first ends of the flock fibers. In step 520, a silicone adhesive contacted on the flock layer 240. The contacting of the silicone adhesive, in step 520, with the flock layer 240 can include screen-printing the silicone adhesive layer 230. Step 520 can include contact the silicone adhesive 230 with the second ends of the flock fibers. More specifically, a first surface of the screen-printed silicone adhesive layer 230 is in contact with second ends of the flock fibers. The first surface of the silicone adhesive layer 230 is in an opposing relationship with a second surface of the silicone adhesive layer 230. The second surface of the silicone adhesive layer 230 is sometimes also referred to as the free surface of the silicone adhesive layer 230. Step 530 can include applying a thermo-adhesive 220 to the silicone adhesive layer 230. More specifically, in step 530 can include applying a thermo-adhesive 220 to the second surface of the silicone adhesive layer 230. The process 500 can also include a step of applying thermal energy (not depicted in FIG. 9) to the flock transfer 600 to cure the silicone adhesive layer 230. The thermal energy can also fuse the thermo-adhesive layer 220 to the silicone adhesive layer 230.

An advantage of the flocked products of present disclosure having a silicone adhesive layer 230 and a thermo-adhesive 220 is their ability to retain their plush flock layer 240 when applied to a substrate 290 with an iron. The flock products of prior art, such as those of FIGS. 1 and 2, do not retain their plushness when applied with an iron. When applied with an iron, one or more of the latex adhesive 275 and hot melt adhesive 222 flow between the fibers and disrupt the plushness of the flock layer 240. When applied by an iron the silicone adhesive 230 of the present disclosure does not substantially flow into the flock fiber layer 240 or disrupt the plushness of the flock fiber layer 240.

It can be appreciated that one or more voids can be created in anyone of the direct flocked product 90, flocked product 200, flocked product 400 or flock transfer product 600. The one or more voids can be created by laser cutting or any other cutting process know in the art. An insert textile or any other suitable design media can be laminated to the cut product/transfer such that the textile design (or other design media) fits and/or is visible within the one or more voids. This method/process is more efficient and provides for a superior product (in terms of one or more of adhesive strength, less manufacturing steps, less matting of flock fibers, cleaner cut edges, to name a few) than manufacturing process. The current process of the prior art includes the steps of: (a) provide a sheet of the textile (or other design media) to-be-inserted with a thermo-adhesive film backing; (b) print an adhesive (thermo-adhesive or silicone adhesive) on the textile (or other design media); (c) direct flock each flock color into the adhesive (thermo-adhesive or silicone adhesive); (d) dry and cure the adhesive (thermo-adhesive or silicone adhesive); (e) vacuum clean; and (f) final cut of product. The final product of step (f) is generally of lesser quality than the product made using flock one of prior art flocked transfer 10 or flocked product 20 for one or one of following: (i) heat pressing leaves the flock fibers, in the current utilized process, matted down a bit when the latex adhesive get tacky when dried and cured; (ii) edges of flock design, in the current utilized process, not clear as the heat pressed edge fibers matt down sideways; and (iii) flock, in the current utilized process, is not very soft because of the depth to which the flock fibers must be planted in the latex adhesive.

In accordance with some embodiments, less of the fiber length is adhered to the silicone adhesive layer 230 than to one or more of the latex adhesive 270 and hot melt adhesive 222; Generally, flock adhered to a silicone adhesive 230 where less of the flock fiber length is adhered to the silicone adhesive 230, is generally dramatically softer than flock adhered to one or more of a latex adhesive 270 and hot-melt adhesive 222 where more of the flock fiber is adhered to the adhesive.

In some embodiments, substantially less flock fibers are matted down in the silicone adhesive 230 compared to one or both of latex adhesive 270 and hot-melt adhesive 222.

In some embodiments, the flock layer edges for flock fibers 240 adhered to silicone adhesive layer 230 are clearer and sharper than the flock edges of the prior art where the flock fibers 240 are adhered to one or more a latex adhesive layer 270 and a hot-melt adhesive layer 222.

In some embodiments, the processes described herein using a silicone adhesive 230 compared to the prior art process that use one or more of a latex adhesive 270 and hot-melt adhesive 222 are generally faster. The processes using a silicone adhesive 230 typically do not require an air-drying step to remove water from an aqueous latex. The silicone adhesive 230 usually polymerizes than one or more of latex adhesive 270 and/or thermally sets more quickly than the hot-melt adhesive 222. Hence, the processes using the silicone adhesive 230 are usually faster than those using a latex adhesive 270 and/or hot-melt adhesive 222.

In some embodiments, the silicone adhesive 230 has less shrinkage than the one or more of latex adhesive 270 and the hot-melt adhesive 222. The latex adhesives 270 of the prior art shrink to about 40% of its printed wet thickness. It is believed that the thicker latex adhesive films 270 cause flock layer 240 to be less plush than those of the thinner silicone adhesive 230 layers described herein.

In some embodiments, the silicone adhesive layer 230 can be electrically conductive. While not wanting to be limited by example, the silicone adhesive layer 230 can contain one or conductive materials such as without limitation an electrically conductive silicone, electrically conductive polymeric material, electrically conductive inorganic material, electrically conductive organic material, or an electrically conductive mixture thereof. The electrically conductive silicone can comprise one of a positively charged fumed silica, a negatively charged fumed silica, and a mixture or combination thereof. The electrical conductivity of the silicone adhesive layer 230 can aid in the deposition and/or contacting of the flock fibers 240 with the silicone adhesive layer 230.

It is believed that when the silicone adhesive layer 230 can lack in some embodiments sufficient electric conductivity. That is, the electric potential between the flock fiber 230 and silicone adhesive layer 230 can be insufficient to substantially deposit and/or contact some of the flock fibers 240 with the silicone adhesive layer 230. Moreover, when the silicone adhesive layer 230 lacks sufficient electrical conductivity, some of the flock fibers 240 are insufficiently deposited and/or contacted with the silicone adhesive layer 230 such that they do not stand proud. That is, some the flock fibers 240 that are insufficiently deposited and/or adhered to the silicone adhesive layer 230 and are oriented, relative to the silicone adhesive layer 230, at an angle from about 35 to about 85 degrees.

Some embodiments can include a step of providing a carrier sheet with a release adhesive. The release adhesive can be a silicone-release adhesive.

Some embodiments can include a step of printing a silicone adhesive 230 onto a release adhesive.

Some embodiments can include a step of applying a thermo-adhesive 220. The thermo-adhesive 220 can be applied to the printed silicone adhesive layer 230. The thermo-adhesive 220 can be provided as a powder. The powdered thermo-adhesive 220 typically has a particle size from about 80 to about300 microns, more typically from 80 to about 200 microns. In some embodiments, the powdered hot-melt adhesive 220 has a particle size from about 200 to about 300 microns. It can be appreciated that the particle size of the powdered hot-melt adhesive 220 can refer to any one or more of the P₉₀, P₈₅, P₈₀, P₇₅, P₇₀ and P₅₀ particle size.

In some embodiments, the thermo-adhesive can be a self-supporting, substantially continuous roll of a thermo-adhesive film. The self-supporting, substantially continuous roll of a thermo-adhesive film typically has first and second opposing sides. One or both of the first and second sides may or may not be in contact with a release sheet.

Some embodiments can include a step of applying thermal energy to one or more of anyone of the direct flocked product 90, flocked product 200, flocked product 400 or flock transfer product 600 to cure the silicon adhesive 230 and adhesively bond the flock fibers 240 to the silicone adhesive 230. In some embodiments, the applied thermal energy can adhesively bond the flock fibers 240 to the thermo-adhesive 220. In some embodiments, the applied thermal energy can adhesively bond the thermo-adhesive 220 and silicone adhesive 230 together.

Some embodiments can include a step of vacuuming the one or more of anyone of the direct flocked product 90, flocked product 200, flocked product 400 or flock transfer product 600 to remove any free flock fibers not adhered to the silicone adhesive 230. The step of vacuuming the one or more of anyone of the direct flocked product 90, flocked product 200, flocked product 400 or flock transfer product 600 can also remover any free powered thermo-adhesive 220.

Some embodiments can include a step of cutting the one or more of anyone of the direct flocked product 90, flocked product 200, flocked product 400 or flock transfer product 600. The cutting can be one of laser cutting, mechanical cutting, hot-wire cutting, or radio frequency cutting.

Commonly, the printed silicone adhesive layer 230 can have a thickness of no more than about 0.1 mm, more commonly of no more than about 0.2 mm, even more commonly of no more than about 0.3 mm, yet even more commonly of no more than about 0.4 mm, still yet even more commonly of no more than about 0.5 mm, still yet even more commonly of no more than about 0.6 mm, still yet even more commonly of no more than about 0.7 mm, still yet even more commonly of no more than about 0.8 mm, still yet even more commonly of no more than about 0.9 mm, still yet even more commonly of no more than about 1.0 mm, still yet even more commonly of no more than about 1.1 mm, still yet even more commonly of no more than about 1.2 mm, still yet even more commonly of no more than about 1.4 mm, still yet even more commonly of no more than about 1.5 mm, or yet still even more commonly of no more than about 1.6 mm. The cured silicone adhesive film typically has a thickness of no more than about 110% of printed silicone adhesive film, more typically of no more than about 105%, even more typically of no more than about 100%, yet even more typically of no more than about 98%, still yet even more typically of no more than about 95%, still yet even more typically of no more than about 93%, still yet even more typically of no more than about 92%, still yet even more typically of no more than about 90%, still yet even more typically of no more than about 88%, still yet even more typically of no more than about 86%, still yet even more typically of no more than about 84%, still yet even more typically of no more than about 82%, still yet even more typically of no more than about 80%, still yet even more typically of no more than about 78%, still yet even more typically of no more than about 76%, still yet even more typically of no more than about 74%, still yet even more typically of no more than about 72%, still yet even more typically of no more than about 68%, still yet even more typically of no more than about 66%, still yet even more typically of no more than about 62%, or yet still even more typically of no more than about 60% of the thickness of printed silicone adhesive layer 230.

In some embodiments, the silicone adhesive layer 230 commonly has an uncured thickness from about 2 to about 15 mils ( 1/1000 of an inch), more commonly from about 3 to about 7 mils ( 1/1000 of an inch).

In some embodiments, the printed silicone adhesive layer 230 typically has a thickness of at least about 0.0010 inches, more typically the silicone adhesive layer 230 has a thickness of at least than about 0.0025 inches, even more typically the silicone adhesive layer 230 has a thickness of at least about 0.0050 inches, and yet even more typically the silicone adhesive layer 230 has a thickness of at least about 0.0075 inches, and still yet even more typically the silicone adhesive layer 230 has a thickness of at least about 0.0100 inches and a thickness of no more than about 0.0750 inches, even more typically a thickness of no more than about 0.0500 inches, even more typically a thickness of no more than about 0.0250 inches, and even more typically a thickness of no more than about 0.0100 inches. In other embodiments, the printed silicone adhesive layer 230 usually has a thickness of at least about 15 μmm, more usually the silicone adhesive layer 230 has a thickness of at least than about 20 μmm, even more usually the silicone adhesive layer 230 has a thickness of at least about 50 μmm, and yet even more usually the silicone adhesive layer 230 has a thickness of at least about 80 μmm, still yet even more usually the silicone adhesive layer 230 has a thickness of at least about 100 μmm, still yet even more typically the silicone adhesive layer 230 has a thickness of at least about 150 μmm, or still yet even more usually the silicone adhesive layer 230 has a minimum thickness of at least about 200 μmm. Commonly the printed silicone adhesive layer 230 has a thickness of no more than about 210 μmm, even more commonly a film thickness of no more than about 200 μmm, even more commonly a film thickness of no more than about 150 μmm, and even more commonly a film thickness of no more than about 105 μmm. Generally, the printed silicone adhesive layer 230 has a thickness of no more than about 210 μmm, even more generally a film thickness of no more than about 200 μm, even more generally a film thickness of no more than about 150 μmm, and even more generally a film thickness of no more than about 105 μmm and a thickness of more than about at least about 20 μmm, more generally a thickness of more than 50 μm, even more generally a thickness of more than about 80 μmm, and yet even more generally a thickness of more than about 150 μm, and still yet even more generally a thickness of more than about 100 μmm.

Generally, the printed film thickness of the silicone adhesive layer 230 is sufficiently thin that the flock fibers do not over-penetrate the silicone adhesive film to create aesthetic issues, such as, but not limited to matting, stiffness and/or lack of plushness of the flock layer. In some embodiments, the pressure applied when contacting the flock fibers 240 with the silicone adhesive 230 is commonly from about 0.01 to about 10 bars, more generally from about 0.05 to about 7 bar, even more generally from about 0.1 to about 5 bar, yet even more generally from about 0.5 to about 4 bar, and still yet even more generally from about 1 to about 3 bar.

Generally, no more than about 0.1% of the flock fiber length is adhesively bonded to silicone adhesive layer 230, more generally no more than about 0.2%, even more generally no more than about 0.3%, yet even more generally no more than about 0.4%, still yet even more generally no more than about 0.5%, still yet even more generally no more than about 0.6%, still yet even more generally no more than about 0.7%, still yet even more generally no more than about 0.8%, still yet even more generally no more than about 0.9%, still yet even more generally no more than about 1.0%, still yet even more generally no more than about 1.1%, still yet even more generally no more than about 1.2%, still yet even more generally no more than about 1.3%, still yet even more generally no more than about 1.4%, still yet even more generally no more than about 1.5%, still yet even more generally no more than about 1.6%, still yet even more generally no more than about 1.7%, still yet even more generally no more than about 1.8%, still yet even more generally no more than about 1.9%, still yet even more generally no more than about 2.0%, still yet even more generally no more than about 2.1%, still yet even more generally no more than about 2.2%, still yet even more generally no more than about 2.3%, still yet even more generally no more than about 2.4%, still yet even more generally no more than about 2.5%, still yet even more generally no more than about 2.6%, still yet even more generally no more than about 2.7%, still yet even more generally no more than about 2.8%, still yet even more generally no more than about 2.9%, still yet even more generally no more than about 3.0%, still yet even more generally no more than about 3.1%, still yet even more generally no more than about 3.2%, still yet even more generally no more than about 3.3%, still yet even more generally no more than about 3.4%, or yet still even more generally no more than about 3.5% of the flock fiber length is adhesively bonded to silicone adhesive layer 230.

The second fiber ends of the flock fibers 240 can be in contact with the silicone adhesive layer 230. At least some of the flock fiber length can be embedded in the silicone adhesive layer 230. In some embodiments, typically no more than about 3% of the flock fiber length can be embedded in the silicone adhesive layer 230, more typically no more than about 2% of the flock fiber length can be embedded in the silicone adhesive layer 230, even more typically no more than about 1.5% of the flock fiber length can be embedded in the silicone adhesive layer 230, yet even more typically no more than about 1% of the flock fiber length can be embedded in the silicone adhesive layer 230, still yet even more typically no more than about 0.5% of the flock fiber length can be embedded in the silicone adhesive layer 230, still yet even more typically no more than about 0.25% of the flock fiber length can be embedded in the silicone adhesive layer 230, or yet still even more typically no more than about 0.1% of the flock fiber length can be embedded in the silicone adhesive layer 230. Commonly, the total surface area of the flock fiber adhered to the silicone adhesive layer 230 comprises more than about 80% of one of the circular faces of the flock fiber 240 and no more than about 20% of the cylindrical wall of the flock fiber, more commonly more than about 85% one of the circular faces of the flock fiber and no more than about 15% of the cylindrical wall of the flock fiber, even more commonly more than about 90% one of the circular faces of the flock fiber and no more than about 10% of the cylindrical wall of the flock fiber, yet even more commonly more than about 95% one of the circular faces of the flock fiber and no more than about 5% of the cylindrical wall of the flock fiber, still yet even more commonly more than about 98% one of the circular faces of the flock fiber and no more than about 2% of the cylindrical wall of the flock fiber, still yet even more commonly more than about 99% one of the circular faces of the flock fiber and no more than about 1% of the cylindrical wall of the flock fiber, and yet still even more commonly more than about 99.5% of one of the circular faces of the flock fiber and no more than about 0.5% of the cylindrical wall of the flock fiber.

Typically, the second fiber ends of the flock fibers 240 are embedded in the silicone adhesive layer 230 to a depth of no more than about 25% of the silicone adhesive layer thickness, more typically the second fiber ends are embedded in the silicone adhesive layer adhesive 230 to a depth of no more than about 15% of the silicone adhesive layer thickness, even more typically the second fiber ends are embedded in the silicone adhesive layer 230 to a depth of no more than about 10% of the silicone adhesive layer thickness, yet even more typically the second fiber ends are embedded in the silicone adhesive layer 230 to a depth of no more than about 5% of the silicone adhesive layer thickness, still yet even more typically the second fiber ends are embedded in the silicone adhesive layer 230 to a depth of no more than about 2.5% of the silicone adhesive layer thickness, still yet even more typically the second fiber ends are embedded in the silicone adhesive layer 230 to a depth of no more than about 2% of the silicone adhesive layer thickness, yet still even more typically the second fiber ends are embedded in the silicone adhesive layer 230 to a depth of no more than about 1% of the silicone adhesive layer thickness, still yet even more typically the second fiber ends are embedded in the silicone adhesive layer 230 to a depth of no more than about 0.5% of the silicone adhesive layer thickness, or still yet even more typically the second fiber ends are embedded in the silicone adhesive layer 230 to a depth of no more than about 0.25% of the silicone adhesive layer thickness.

It can be appreciated that the flock fiber 240 length in contact with the silicone adhesive layer 230 can depend on one or both pressure and temperature applied when contacting the flock fibers 240 with the silicone adhesive layer 230 and the physical properties of the silicone adhesive layer 230 during the embedding process.

The flock layer 240 comprises a plurality of interstitial voids between the flock fibers 204, the plurality of interstitial voids has an interstitial void volume. Generally, substantially some of the silicone adhesive layer 230 flows into at least some the interstitial void volume. More generally, substantially little, if any, of the silicone adhesive layer 230 flows into at least some the interstitial void volume. Even more generally, substantially none the silicone adhesive layer 230 flows into most of the interstitial void volume. Yet even more generally, substantially most, or all, of the interstitial void volume is substantially free the silicone adhesive layer 230. Still yet more generally, the interstitial void volume is substantially free the silicone adhesive layer 230.

In some embodiments, the silicone adhesive 105 generally has a cured film thickness from about 2 to about 15 mils ( 1/1000 of an inch), more generally from about 3 to about 7 mils ( 1/1000 of an inch).

In some embodiments, the cured silicone adhesive layer 230 typically has a thickness of at least about 0.0010 inches, more typically the silicone adhesive layer 230 has a thickness of at least than about 0.0025 inches, even more typically the silicone adhesive layer 230 has a thickness of at least about 0.0050 inches, and yet even more typically the silicone adhesive layer 230 has a thickness of at least about 0.0075 inches, and still yet even more typically the silicone adhesive layer 230 has a thickness of at least about 0.0100 inches and a thickness of no more than about 0.0750 inches, even more typically a thickness of no more than about 0.0500 inches, even more typically a thickness of no more than about 0.0250 inches, and even more typically a thickness of no more than about 0.0100 inches. In other embodiments, the cured silicone adhesive layer 230 usually has a minimum thickness of at least about 15 μmm, more usually the silicone adhesive layer 230 has a thickness of at least than about 20 μmm, even more usually the silicone adhesive layer 230 has a thickness of at least about 50 μmm, and yet even more usually the silicone adhesive layer 230 has a thickness of at least about 80 μmm, still yet even more usually the silicone adhesive layer 230 has a thickness of at least about 100 μmm, still yet even more typically the silicone adhesive layer 230 has a thickness of at least about 150 μmm, or still yet even more usually the silicone adhesive layer 230 has a thickness of at least about 200 μmm. Commonly the cured silicone adhesive layer 230 has a thickness of no more than about 210 μmm, even more commonly a film thickness of no more than about 200 μmm, even more commonly a film thickness of no more than about 150 μmm, and even more commonly a film thickness of no more than about 105 μm. Generally, the cured silicone adhesive layer 230 has a thickness of no more than about 210 μm, even more generally a film thickness of no more than about 200 μm, even more generally a film thickness of no more than about 150 μm, and even more generally a film thickness of no more than about 105 μm and a thickness of more than about at least about 20 μm, more generally a thickness of more than 50 μm, even more generally a thickness of more than about 80 μm, and yet even more generally a thickness of more than about 150 μm, and still yet even more generally a thickness of more than about 100 μm.

Generally, no more than about 0.1% of the flock fiber length is adhesively bonded to silicone adhesive layer 230, more generally no more than about 0.2%, even more generally no more than about 0.3%, yet even more generally no more than about 0.4%, still yet even more generally no more than about 0.5%, still yet even more generally no more than about 0.6%, still yet even more generally no more than about 0.7%, still yet even more generally no more than about 0.8%, still yet even more generally no more than about 0.9%, still yet even more generally no more than about 1.0%, still yet even more generally no more than about 1.1%, still yet even more generally no more than about 1.2%, still yet even more generally no more than about 1.3%, still yet even more generally no more than about 1.4%, still yet even more generally no more than about 1.5%, still yet even more generally no more than about 1.6%, still yet even more generally no more than about 1.7%, still yet even more generally no more than about 1.8%, still yet even more generally no more than about 1.9%, still yet even more generally no more than about 2.0%, still yet even more generally no more than about 2.1%, still yet even more generally no more than about 2.2%, still yet even more generally no more than about 2.3%, still yet even more generally no more than about 2.4%, still yet even more generally no more than about 2.5%, still yet even more generally no more than about 2.6%, still yet even more generally no more than about 2.7%, still yet even more generally no more than about 2.8%, still yet even more generally no more than about 2.9%, still yet even more generally no more than about 3.0%, still yet even more generally no more than about 3.1%, still yet even more generally no more than about 3.2%, still yet even more generally no more than about 3.3%, still yet even more generally no more than about 3.4%, or yet still even more generally no more than about 3.5% of the flock fiber length is adhesively bonded to silicone adhesive layer 230.

Some embodiments of the present disclosure include a molding process. In some embodiments, the appliqué and/or transfer can comprise a metalized polymeric film. The metalized polymeric film can comprise a metallized polyurethane polymeric film. In such embodiments, a silicone adhesive layer 230 can be positioned adjacent to and in contact with the metallized polymeric film and placed in and against a metal mold and then orientated in a heat transfer machine to crosslink the silicone adhesive 230 while forming the appliqué and/or transfer into a geometric shape. The metalized polymeric film appliqué and/or transfer can further comprise flock (or other such decorative element such as woven or knitted textiles) a three-dimensional flocked (or textile) image can be formed. More specifically the metallized polymeric film and the one or more of flock and woven and/or knitted textile, can be combined and heat-cured in a mold so that the silicone adhesive layer 230 is formed into a shape as it is cured. It can be appreciated, that the flocked image can be dimensionally heat-formed in three-dimensions and that the three-dimensional shape. can be retained its shape. Moreover, the three-dimensional shape is not substantially affected by subsequent exposure to heat or pressure. Examples of metallized polymeric elements include without limitation U.S. Pat. Nos. 7,799,164 and 9,193,214, both to Abrams, U.S. Pat. Nos. 8,110,059; 5,589,022; 5,677,037; 5,599,416; 5,520,988; and 5,143,672, all of which are incorporated in their entirety herein by this reference.

Further embodiments can include a cured silicone adhesive layer 230 having an elasticity from about 300 to 1,000 percent. Some embodiments can include a flocked transfer having an elasticity from about 300 to 1,000 percent. Some embodiments can include a flocked transfer having a cured silicone adhesive and an elasticity from about 300 to 1,000 percent.

Some embodiments include a screen printable silicone adhesive that commonly has a cure time of from about 45 to about 75 seconds, more commonly of about 60 seconds.

The pressure sensitive adhesive 250 can be selected such that the bonding force between the pressure sensitive adhesive 250 and the plurality of flock fibers 240 is less than the bonding force between the silicone adhesive layer 230 and the plurality of flock fibers 240. The pressure sensitive adhesive 250 can be any adhesive that adheres more strongly to the release sheet 210 than the plurality of flock fibers 240 but adheres to both enough to hold them together. For example, the pressure sensitive adhesive 250 may be any temporary adhesive, such as a resin or a copolymer, e.g., a polyvinyl acetate, polyvinyl alcohol, polyvinyl chloride, polyvinyl butyral, acrylic resin, polyurethane, polyester, polyamides, cellulose derivatives, rubber derivatives, starch, casein, dextrin, gum arabic, carboxymethyl cellulose, rosin, silicone, or compositions containing two or more of these ingredients. Generally, the pressure sensitive adhesive 250 can be a water-based adhesive, that is the pressure sensitive adhesive 250 is one or more of dispersed, dissolved, suspended or emulsified within water.

It is believed that after removing the release sheet 210 from flock transfer 600 a residual amount of the pressure sensitive adhesive 250 remains on the flock fiber 240. It is further believed that the residual amount of the pressure sensitive adhesive 250 remaining on the flock fiber negatively effects the ability of the flock fibers 240 to adhere to an adhesive. The direct flock products of the present invention overall this limitation.

The plurality of flock fibers 240 may be formed from any natural or synthetic material. Synthetic material can include, without limitation, one or more of vinyl, rayon, nylon, polyamide, polyester, acrylic, and a natural material. The polyester can comprise a terephthalate polymers, such as poly(ethylene terephthalate) and poly(cyclohexylene-dimethylene terephthalate). The natural material can be one or more of cotton and wool. In some embodiments, a conductive coating or finish can be applied continuously or discontinuously over the exterior surface of the flock fibers 240. The conductive coating can permit the flock fibers 102 to retain an electrical charge.

The flock fibers 240 can be pre-colored (yarn-dyed, by a dye sublimation process, or spun dyed) before contacting one or more of the pressure sensitive adhesive 250 or the silicone adhesive layer 230 or after the release sheet 210 is removed.

At least most, or commonly at least about 75%, and more commonly all, of the flock fibers 240 can have a denier of typically of no more than about 60, more typically of no more than about 25, or even more typically no more than about 5. The flock fibers 240 generally have a denier from about 1.5 to about 3.5. Commonly, the flock fibers 240 can have a titre ranging from about 0.5 to about 20 Dtex (from about 0.5 to about 20×10⁻⁷ Kg/m) and more commonly from about 0.9 Dtex to about 6 Dtex. The length of at least most, and typically at least about 75%, of the flock fibers 240 is generally no more than about 4 mm, more generally no more than about 2 mm, and even more generally no more than about 1 mm. Usually, the flock fibers 240 have a length ranging from about 0.3 to about 3.5 mm. The flock fiber 240 placement density relative to the surface area of the flocked portion (on which the flock is deposited) of the flock product and/or flock transfer is generally about 50% fibers/in², more generally at least about 60% fibers/in², and even more generally at least about 70% fibers/in² of the flocked surface area.

Three silicone adhesive formulations 230A-230F were evaluated. The first silicone adhesive 230A had excellent integrity; however, when screen printed it was stringy. The stringy nature of the first silicone adhesive 230A rendered it unsuitable for screen printing. The second silicone adhesive 230B was more screen printable but it had less adhesive integrity than the first silicone adhesive 230A. Furthermore, the second silicone adhesive 230B had low tensile strength and was too soft. The third silicone adhesive 230C had a low viscosity, it would not sit up on top of flock fibers and sank down into the flock fiber layer. Three other silicone adhesive formulations 230D, 230E and 230F were evaluated. Each of formulations 230D, 230E and 230F comprised a mixture of methyltrimethoxysilane treated with aluminum oxide, methylvinyl siloxane hydroxy-terminated reaction product with glycidoxyproply trimethoxysilance and methyltrioxysilane-treated aluminum oxide. The silicone adhesive formulations 230E and 230F further include, respectively, an ultra-high molecular weight additive and silica powder thickener, the silicone adhesive formulation 230D did not have either of the ultra-high molecular weight additive and silica powder thickener. The silicone adhesive 230D is a suitable base product. However, silicone adhesive 230D is soft, weak and time; it is generally printed down into the textile rather than standup on top of the textile. The addition of ultra-high molecular weight additive and silica powder thickener to the silicone adhesive formulation introduced entrained air into the silicone adhesive which caused the adhesive to have stringiness when screen-printed. As such the screen print quality poor.

Some formulations of the silicone adhesive 230 can a rheology modifier comprising one or more of silicone dioxide (SiO₂), titanium dioxide (TiO₂), and aluminum oxide (Al₂O₃). In some embodiments, the silicone adhesive 230 can include a rheology modifier comprising fumed silica. The silicone adhesive formulation can commonly have from about 0.01 to about 0.1 wt %, more commonly from about 0.1 to about 1.0 wt %; even more commonly from about 1.0 to about 5.02 wt %, yet even more commonly from about 5.0 to about 10. 0 wt %, or still yet even more commonly from about 10.0 to about 25.0wt % of the rheology modifier.

In some embodiments, the screen printable pot life of the two-component silicone adhesive after mixing of the two components is commonly from about one to about six hours, more commonly from about one and half to about five hours, even more commonly from about 2 to about four hours.

The plurality of flock fibers 240 in anyone of the direct flocked product 90, flocked product 200, flocked product 400 or flock transfer product 600 can be adhered to a substrate 290 by the silicone adhesive layer 230. That is, substrate 290 can be in contact with and adhered to one or more of the silicone adhesive layer 230 and thermo-adhesive 220. The substrate 290 can comprise any material. Non-limiting examples of suitable substrates 290 materials can comprise metallic materials, synthetic or natural polymeric materials, glass-based materials, ceramic materials, leather-based materials and combinations thereof. Furthermore, the substrate 290 may or may not be stretchable and/or have elastic properties.

Generally, the substrate 290 is a textile material. The textile material can be woven, nonwoven, or knit. More generally, the substrate 290 can be a stretchable and/or elastomeric textile material, such as stretchable and/or elastomeric fabric and/or apparel item. Even more generally, the substrate 290 can comprise one or more of an elastomeric polymeric material and a stretchable-knit and/or stretchable-woven material. It can be appreciated that when the anyone of the direct flocked product 90, flocked product 200, flocked product 400 or flock transfer product 600 is adhered to a textile material by one or more of the silicone adhesive 230 and thermo-adhesive 220, the adhesive bond between the flock fibers 240 and substrate 290 is substantially strong to withstand industrial wash testing. Generally, the adhesive bond between the flock fibers 240 and substrate 290 can withstand one of more than 10, 20, 30, 40, 50, 60, 70, 80, 90, 100, 125, 150, 175, 200, 225, 250, 275, 300, 350, 400, 450, 500, 600, 700, 800, 900, or 1,000 industrial wash cycles without substantial delamination of adhesive bond.

Non-limiting examples of elastomeric polymeric materials comprise one or more of rubbers, polyisoprenes, polybutadinenes, styrene-butadienes, chloroprenes, ethylene propylene rubbers, ethylene-vinyl acetates, ethylene propylene diene rubbers, polyacrylic rubbers, epichlorohydrin rubbers, fluorosilicones, fluoroelasters, silicones, perfluoroelastomers, polyether block amides, chlorosulfonated polyethylenes and combinations thereof). Non-limiting examples of stretchable-knits/stretchable-weaves are sprang weaves, mesh-weaves, open weaves, warp knits, and two-way knits. While not wanting to be limited by an example, suitable stretchable-knits/stretchable-weave textile materials are LYCRA™ (a trademark of Invista), an elastane containing material, Spandex™, 4-, 3-, 2-, or 1-way stretch fleece fabrics, and stretch cotton weaves (such as, stretch rayon jersey knit and/or cotton/LYRCA™ combinations).

In some embodiments, the stretchable and/or elastomeric material can be stretched to at least about 1.2 times of its original length in at least one direction, at least about 1.5 times of its original length in at least one direction, at least about 1.8 times of its original length in at least one direction or at least about 2.0 times of its original length in at least one direction. In some embodiments, the stretchable and/or elastomeric fabric post-stretched length, in the stretched direction, deviates from the pre-stretched length, in the stretched direction, commonly by no more than about 5%, more commonly by no more than about 2%, even more commonly by no more than about 1%, even more commonly by no more than about 0.5%, and even more commonly by no more than about 0.2%.

In some embodiments, the substrate 290 can comprise an item of apparel, preferably a stretchable and/or elastomeric item of apparel. Non-limiting examples of stretchable items of apparel are jerseys, leotards, pants, shirts, blouses, leggings, socks, shoes, swim and/or beach wear, athletic apparel, medical, under garments, jackets, rain gear, sweaters, and accessories. Accessories can include, without limitation, hair-bands, wrist bands, head bands, finger bands, ankle bands, rain gear, finger bands, toe-bands, arm bands, and shoe-laces.

In some embodiments, the substrate 290 can comprise non-apparel items, such as, but not limited to: dog leases, pet clothing, towels, bedding, upholstery (for home, automobile, office, garden, and beach), luggage (hard and soft), ladies' handbags, recreational and sporting items, packing, totes and carpeting.

The substrate 290 can have a single surface or a plurality of surfaces. Non-limiting examples of a single-surfaced substrate 290 are substrates having one of a generally spherical, circular-donut, and elliptical-donut shapes. Non-limiting examples of substrate shapes having a plurality of substrate surfaces are substrates substantially resembling one of a cube, rectangular-box and tetrahedral shapes.

In some embodiments, the substrate 290 can comprise a substantially thick textile material, such as, but not limited to, a high pile, or loosely and/or bulky woven or knitted textile. Non-limiting examples of a high pile substrate are sweatbands and terrycloth items. The substantially thick textile material can provide a stable foundation and/or base for adhering any of the direct flocked product 90, flocked product 200, flocked product 400 or flock transfer product 600.

Typically, the direct flocked product 90, flocked product 200, flocked product 400 and/or flock transfer product 600 adhered to a substrate 290 by a substantially flexible and/or elastic silicone adhesive layer 230 is substantially free of one or more of splitting, delamination and distortion after applying at least one cycle of an elongation or angular stress to the substrate 290. More typically, more typically the direct flocked product 90, flocked appliqué 200, flocked appliqué 400 or flock transfer product 600 adhered to a substrate 290 by a substantially flexible and/or elastic silicone adhesive layer 230 is substantially free of one or more of splitting, delamination and distortion after repeatability applying an elongation and/or angular stresses to the substrate 290 at least 100 times, even more is substantially free of one or more of splitting, delamination and distortion after repeatability applying elongation and/or angular stresses to the substrate 290 at least 500 times, yet even more typically is substantially free of one or more of splitting, delamination and distortion after repeatability applying elongation and/or angular stresses to the substrate 290 at least 1,000 times, still yet even more typically is substantially free of one or more of splitting, delamination and distortion after repeatability applying elongation and/or angular stresses to the substrate 290 at least 10,000 times, or still yet even more typically is substantially free of one or more of splitting, delamination and distortion after repeatability applying elongation and/or angular stresses to the substrate 290 at least 100,000 times.

In some embodiments, the cured silicone adhesive layer 230 has elastomeric properties. Generally, the cured silicone adhesive layer 230 can have an elongation, without one or more of fracturing or rupture, of more than about 200%, more generally more than about 300%, even more generally of more than about 500%, yet even more generally of more than about 750%, and still yet even more commonly of more than about 1,000%. Typically, the cured silicon adhesive layer 230 can have a recovery after elongation of one of more than about 75%, more typically of more than about 90%, even more typically of more than about 95%, yet even more typically of more than about 98%, still yet even more typically of more than about 99%, or yet still even more typically of substantially about 100%. The elongation recovery is the percent of the film's shape retained after the film is stretched to 100% or more of its original length at a rate of 30 inches per minute and the stretched film allowed to retract freely for 1 minute.

Generally, the silicone adhesive layer 230 is contact with and adhered to the substrate 290. The silicone adhesive layer 230 generally one of penetrates and/or contacts at least some of the substrate 290. By way of a non-limiting example, the substrate 290 can have a pile thickness Tₚᵢₗₑ. Typically, the silicone second adhesive layer 230 in contact with the substrate 290 has an adhesive thickness of about equal to T_{adh}, more typically the adhesive in contact with the substrate has a thickness of no more than about one-half of T_{adh}, even more typically the adhesive in contact with the substrate has a thickness of no more than about one-quarter of T_{adh}, yet even more typically the adhesive in contact with the substrate has a thickness of no more than about one-eighth of T_{adh}, still yet even more typically the adhesive in contact with the substrate has a thickness of no more than about one-sixteenth of T_{adh}, still yet even more typically the adhesive in contact with the substrate has a thickness of no more than about one-thirty-second of T_{adh}, still yet even more typically the adhesive in contact with the substrate has a thickness of no more than about one-sixty-fourth of T_{adh}, or still yet more typically the adhesive in contact with the substrate has a thickness of no more than about one-one hundredth twenty-eighth of T_{adh}.

The silicone adhesive layer is generally substantially continuously distributed over areal the first extent. Although the first areal extent is shown as being conterminous, this is not necessarily the case. In some embodiments, the silicone adhesive layer is substantially elastic and continuous over the first areal extent. The silicone adhesive layer can have opposing upper and lower silicone adhesive surfaces and a silicone adhesive film thickness. In some embodiments, the silicone adhesive layer can be substantially free of holes and/or voids, respectively, extending through the adhesive film thickness. That is, the silicone adhesive layer is substantially continuously distributed and substantially free of holes and/or voids extending through its respective film thicknesses and throughout its areal extents. Substantially free of holes and/or voids means that on a macroscopic level (that is, not a microscopic and/or molecular level) the silicone adhesive layer thicknesses is greater than zero substantially over at least most, if not all, locations of the areal extent. Stated another way, in some embodiments, the silicone adhesive layer has fewer than about 10, even more generally, no more than about 5, and even more generally, no more than about 1, and even more generally, no holes and/or voids, visible to an un-aided eye of an ordinary human observer, per square centimeter surface area of the areal extent. In some embodiments, the silicone adhesive layer has no more than about 1 hole and/or void visible to an un-aided eye of ordinary human observer over the surface area of the areal extent 2800. In another embodiment, the upper and lower silicone adhesive surfaces are substantially free of interfacial voids and/or valleys. That is, the upper and lower silicone adhesive surfaces are substantially planar and/or flat.

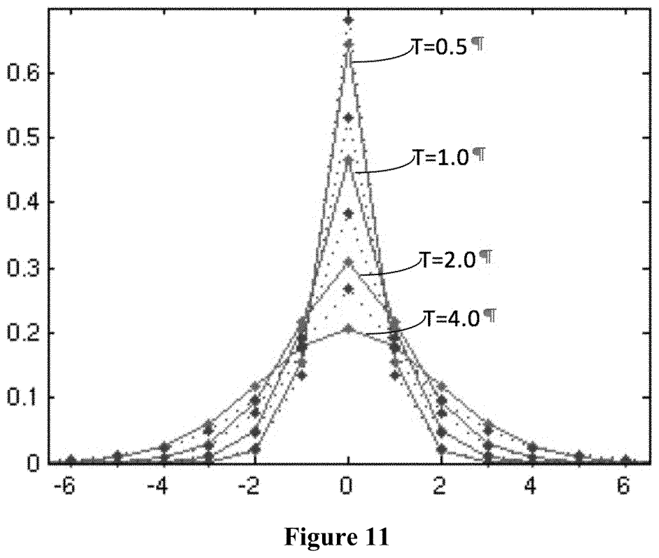

A plurality of film thickness values measured over the areal extent 2800 for the silicone adhesive layer 230 can be represented by a Gaussian distribution, the Gaussian distribution typically has a “t” value (FIG. 11). In some embodiments, the Gaussian “t” value for the silicone adhesive layer 230 is typically less than about 4, more typically less than about 2, even more typically less than about 1, and even more typically less than about 0.5.

The silicone adhesive layer generally has elastomeric properties. More generally, the elastomeric properties of the silicone adhesive layer are substantially independent of any discontinuities that may exist within the adhesive layer. That is, the silicone adhesive is substantially elastomeric with or without discontinuities present within the silicone adhesive layer.

The phrase “substantially continuous” means that a film or layer substantially covers and/or coats the entire areal interface 2800 of a surface over which the film or layer is said to be substantially continuous. Moreover, “substantially continuous” means the film or layer is substantially free of holes and/or voids.

Any of the direct flocked product 90, flocked product 200, flocked product 400 or flock transfer product 600 can further comprise a metalized polymeric film. The metalized polymeric film can have opposing embossed and non-embossed surfaces. The non-embossed surface is usually substantially planar. The embossed surface is commonly substantially non-planar and dimensionalized. Generally, the embossed surface has a metallic luster and color and one or more valleys, ridges, facets, and featherings, which gives the embossed surface the appearance of being an engraved metallic surface. The embossed surface can contain one or more decorative elements. The one or more decorative elements can include simulated carved artwork having fine-line details, such as, scrolls, feathers, alpha-numeric characters, leaves, and such. Furthermore, the metalized polymeric film is commonly free of any cellulosic polymeric materials. Typically, the metalized polymeric film contains a thermoplastic synthetic resin film. More typically, the thermoplastic synthetic resin film is one of vinyl chloride, polyurethane or mixture thereof. The thermoplastic synthetic resin film has opposing upper and lower surfaces. A metal layer can be position on the lower surface. Generally, the metal layer is deposited by known metal vacuum evaporation methods. The metal layer can comprise aluminum, chromium, or titanium. When the metalized polymeric layer is to have the appearance of gold, the metal layer can comprise aluminum, and a gold-color ink layer can be placed on the aluminum metal layer. A transparent vinyl chloride film can be laminated on the gold-color ink layer.

In some embodiments, the metalized polymeric film can be one or more of substantially non-rigid, elastic and flexible. In such embodiments, the metalized polymeric film commonly has an elongation value in at least one direction from about 105% to about 1,000%, more commonly from about 110% to about 500%, even more commonly from about 120% to about 200%, yet even more from about 130% to about 190%, still yet even more commonly from about 150% to about 200%.

The metalized polymeric film can comprise any polymeric material. The polymeric can material comprise one or more of a homopolymer, copolymer, polymer alloy or a combination thereof, and wherein the polymeric material comprises one or more of vinyl esters, epoxies, polyolefins, polystyrenes, polyvinyls, polyacrylics, polyhalo-olefins, polydienes, polyoxides, polyesthers, polyacetals, polysulfides, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, polyphylenes, and combinations and/or mixtures thereof.

In some embodiments, the metalized polymeric film can be one or more of substantially rigid, inflexible, and inelastic. More specifically, the metalized polymeric film can be substantially rigid, inflexible, and inelastic. In some embodiments, the metalized polymeric film can comprise a metallic film. Generally, the one or more of the metalized polymeric film can comprise a metallic film and a polymeric material, more preferably a metallic film supported by the polymeric material. A non-limiting example of the metalized polymeric film comprises polyethylene terphthalate having a metallic film on at least one side of polymeric film.

Generally, any of the direct flocked product 90, flocked product 200, flocked product 400 or flock transfer product 600 having a metalized polymer film can be substantially resistant to one or both of splitting and delamination of the flock fibers 240. More specifically, the metalized polymeric film substantially reduces splitting and/or delamination of the flock fibers 240 from a substantially elastomeric and/or stretchable substrate 290. The metalized polymeric film can reduce stresses imparted to the flock fibers 240 when stress is applied to a substantially elastomeric and/or stretchable substrate 290. More specifically, when a stress is applied to the elastomeric and/or stretchable substrate 290, the applied stress can affect the adherence of the flock fibers 240 to the substrate 290. Furthermore, the a substantially flexible and/or elastic silicone adhesive layer 230 can reduce distortion of the direct flocked product 90, flocked product 200, flocked product 400 and/or flock transfer product 600 when a stress is applied to the substrate 290. The reduced distortion of the direct flocked product 90, flocked product 200, flocked product 400 and/or flock transfer product 600 can be advantageous in retaining its, more specifically the artistic integrity and value of the direct flocked product 90, flocked product 200, flocked product 400 and/or flock transfer product 600.

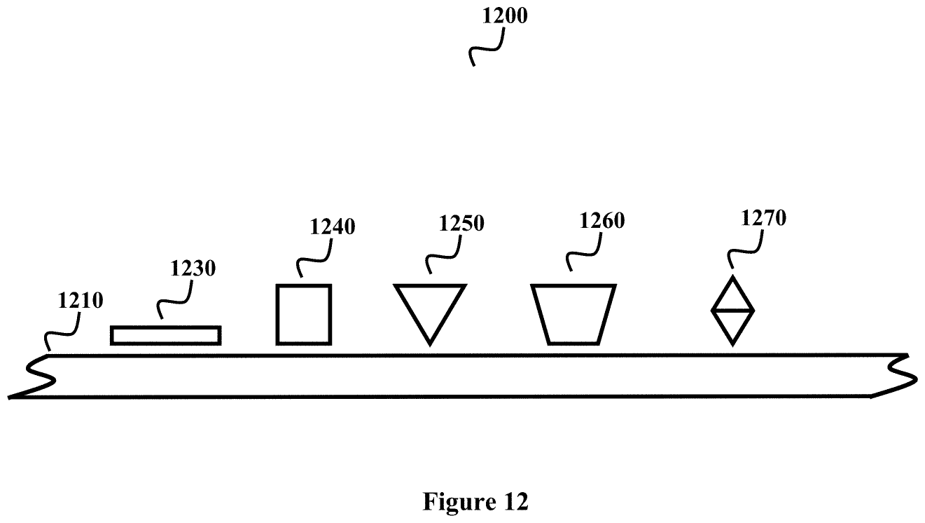

FIG. 12 depicts system 1200 for making some of flock products of the present disclosure. The system includes a device (not depicted) for translating a continuous thermo-set sheet 1210 from one the various units comprising the system. The continuous thermo-set sheet 1210 can comprise one of a thermoplastic adhesive, a thermoset adhesive or combination of thermoplastic and thermoset adhesives. The process 1200 can include an adhesive contacting unit 1230 for applying a silicone adhesive with the continuous thermo-set sheet 1210. The adhesive contacting unit 1230 can be one of a screen printing unit, a curtain unit, a blade applicator, a spray coater, a kiss roller, a brush applicator, or other liquid applicators know to those of skill in the art. Typically, the adhesive contacting unit 1230 comprises a screen printing unit. The process 1200 can include one or more flocking units 1240. Generally, each flocking unit 1240 contacts a different colored flock with to the silicone adhesive printed on the thermo-set sheet 1210. The process 1200 can include a free flock removal unit 1260. The free flock removal unit 1260 removes any flock not adhered to the silicone adhesive. The free flock removal unit 1260 commonly comprises one or more of vacuum unit and vibrator units. The vibrator unit typically shakes and/or beats the continuous thermo-set sheet 1210. The one or more flocking units 1240 are usually positioned between the free flock removal unit 1250 and the adhesive contacting unit 1230. The vacuum unit commonly removes the free flock by a suction and/or reduced pressure. The process 1200 can include a curing unit 1260. The free flock removal unit 1260 is typically located between the curing unit 1260 and the one or more flocking units 1240. The curing unit 1260 generally applies sufficient thermal energy to silicone adhesive to cure it. The process 1200 can include a laser cutting unit 1270. The curing 1260 is generally positioned between the laser cutting unit 1270 and the free flock removal unit 1250. The laser cutting unit 1270 generally forms the flock adhered to the thermo-set sheet by the silicone adhesive film into a flocked product that can assembled into configuration that can be configured into an automated appliqué application process line. For example, the laser cutting unit 1270 can form and configure the flock flocks into container that can be configure into an automated appliqué application process line.

A number of variations and modifications of the disclosure can be used. It would be possible to provide for some features of the disclosure without providing others.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of making a flock product comprising a flock layer having a plurality of flock fibers, a thermo-adhesive layer, and a silicone adhesive layer positioned between the thermo-adhesive and the flock layer, wherein the silicone adhesive layer comprises (a) a catalyst, (b) a siloxane, (c) a vinyl siloxane, and (d) a rheology modifier, the method comprising:
providing the thermo-adhesive layer;
contacting a silicone adhesive with the thermo-adhesive layer, wherein the contacting comprises screen printing the silicone adhesive layer on the thermo-adhesive layer; and
contacting flock fibers with the silicone adhesive layer, wherein the contacting of the flock fibers with the silicone adhesive layer comprises an electrostatic flocking process.

2. A method of making a flock product comprising a silicone adhesive layer having (a) a catalyst, (b) a siloxane, (c) a vinyl siloxane, and (d) a rheology modifier, a flock layer having a plurality of flock fibers, and a release sheet, wherein the silicone adhesive layer is positioned between the flock layer and release sheet and the silicone adhesive is adhered to the release sheet and flock layer, the method comprising:
providing the release sheet;
contacting a silicone adhesive with the release sheet, wherein the contacting comprises screen printing the silicone adhesive layer on the release sheet; and
contacting flock fibers with the silicone adhesive layer, wherein the contacting of the flock fibers with the silicone adhesive layer comprises an electrostatic flocking process.

3. A method of making a flock product comprising a thermo-adhesive layer, a flock layer, a silicone adhesive layer positioned between the thermo-adhesive layer and the flock layer, wherein the silicone adhesive layer comprises (a) a catalyst, (b) a siloxane, (c) a vinyl siloxane; and (d) a rheology modifier, and a carrier sheet, wherein the flock layer is positioned between the carrier sheet and the silicone adhesive layer, the method comprising:
providing the release sheet;
contacting the flock fibers the release sheet, wherein the contacting adheres the flock fibers to the release sheet;
contacting a silicone adhesive with the flock fibers; and
contacting a thermo-adhesive with the free surface of the silicone adhesive.
